(19) United States
(12) Patent Application Publication
(10) Pub. No.: US 2025/0304212 A1
(43) Pub. Date: Oct. 2, 2025

(54) COMPONENT FOR HUMAN-POWERED VEHICLE

(71) Applicant: Shimano Inc., Osaka (JP)

(72) Inventors: Koichi KAJIKI, Osaka (JP); Yoshikazu SATO, Osaka (JP); Hisanori TAKANO, Osaka (JP)

(21) Appl. No.: 19/096,338

(22) Filed: Mar. 31, 2025

(30) Foreign Application Priority Data
Mar. 31, 2024 (JP) 2024-089283

(51) Int. Cl. B62M 25/08; B62J 45/00

(52) U.S. Cl. CPC B62M 25/08; B62J 45/00

(57) ABSTRACT

A component for a human-powered vehicle includes an operating portion configured to be operable by a user, an electric power generator, a transmitter, and a controller. The electric power generator is configured to generate electric power in accordance with displacement of the operating portion in a case where the user operates the operating portion. The transmitter is configured to transmit a predetermined signal to a further component with the electric power generated by the electric power generator. The controller is configured to control the transmitter so that the predetermined signal is transmitted in response to operation of the operating portion. The controller is configured to control the transmitter to change a transmission state of the predetermined signal in accordance with an operating state of the operating portion in a case where the operating portion is operated.

### CROSS-REFERENCE TO RELATED APPLICATIONS

This application claims priority to Japanese Patent Application No. 2024-089283, filed on May 31, 2024. The entire disclosure of Japanese Patent Application No. 2024-089283 is hereby incorporated herein by reference.

### BACKGROUND

### Technical Field

The present disclosure generally relates to a component for a human-powered vehicle.

### Background Information

Japanese Patent No. 6331677 (Patent Document 1) discloses an electric power generator configured to generate electric power in accordance with displacement of an operating portion.

### SUMMARY

An objective of the present disclosure is to provide a human-powered vehicle component that optimally uses electric power generated by an electric power generator.

A component in accordance with a first aspect of the present disclosure is for a human-powered vehicle. The component comprises an operating portion configured to be operable by a user, an electric power generator, a transmitter, and a controller. The electric power generator is configured to generate electric power in accordance with displacement of the operating portion in a case where the user operates the operating portion. The transmitter is configured to transmit a predetermined signal to a further component with the electric power generated by the electric power generator. The controller is configured to control the transmitter so that the predetermined signal is transmitted in response to operation of the operating portion. The controller is configured to control the transmitter to change a transmission state of the predetermined signal in accordance with an operating state of the operating portion in a case where the operating portion is operated.

The component according to the first aspect changes the transmission state of the predetermined signal in accordance with the operating state of the operating portion. This optimally uses the electric power generated by the electric power generator.

In accordance with a second aspect of the present disclosure, the component according to the first aspect is configured so that the operating portion is configured to be displaceable between a first operating position and a second operating position differing from the first operating position. The controller is configured to control the transmitter so that the transmission state becomes a first transmission state in a case where the operating portion is displaced from the first operating position to the second operating position. The controller is configured to control the transmitter so that the transmission state becomes a second transmission state in a case where the operating portion is displaced from the second operating position to the first operating position. The transmitter is configured to consume less electric power in the second transmission state than in the first transmission state.

The component according to the second aspect reduces the electric power consumption in a case where the operating portion is displaced from the second operating position to the first operating position.

In accordance with a third aspect of the present disclosure, the component according to the first aspect is configured so that the operating portion is configured to be displaceable between a first operating position and a second operating position differing from the first operating position. The controller is configured to control the transmitter so that the transmission state becomes a first transmission state in a case where the operating portion is displaced from the first operating position to the second operating position. The controller is configured to control the transmitter so that the transmission state is maintained in a second transmission state while the operating portion is maintained at the second operating position after the operating portion is displaced from the first operating position to the second operating position. The transmitter is configured to consume less electric power in the second transmission state than in the first transmission state.

The component according to the third aspect reduces the electric power consumption in a case where the operating portion is maintained at the second operating position.

In accordance with a fourth aspect of the present disclosure, the component according to any one of the first to third aspects is configured so that the operating portion is configured to be displaceable between a first operating position and a second operating position differing from the first operating position. The controller is configured to control the transmitter so that the predetermined signal is transmitted in a case where the operating portion is displaced from the first operating position to the second operating position. The controller is configured to control the transmitter so that the predetermined signal is not transmitted in a case where the operating portion is displaced from the second operating position to the first operating position.

The component according to the fourth aspect does not transmit the predetermined signal in a case where the operating portion is displaced from the second operating position to the first operating position. This reduces the electric power consumption.

In accordance with a fifth aspect of the present disclosure, the component according to the first aspect is configured so that the operating portion is configured to be displaceable between a first operating position and a second operating position differing from the first operating position. The controller is configured to control the transmitter so that the predetermined signal is not transmitted while the operating portion is maintained at the second operating position after the operating portion is displaced from the first operating position to the second operating position.

The component according to the fifth aspect does not transmit the predetermined signal in a case where the operating portion is maintained at the second operating position. This reduces the electric power consumption.

A component in accordance with a sixth aspect of the present disclosure is for a human-powered vehicle. The component comprises an operating portion configured to be operable by a user, an electric power generator, a transmitter, and a controller. The electric power generator is configured to generate electric power in accordance with displacement of the operating portion in a case where the user operates the operating portion. The transmitter is configured to transmit a predetermined signal to a further component. The controller is configured to be actuated by the electric power generated by the electric power generator. The controller is configured to control the transmitter so that the predetermined signal is transmitted in response to operation of the operating portion. The controller is configured to switch an electric power consumption state of the controller in accordance with an operating state of the operating portion between a first electric power consumption state and a second electric power consumption state in which less electric power is consumed than in the first electric power consumption state.

The component according to the sixth aspect switches the electric power consumption state between the first electric power consumption state and the second electric power consumption state in accordance with the operating state of the operating portion. This optimally uses the electric power generated by the electric power generator.

In accordance with a seventh aspect of the present disclosure, the component according to the sixth aspect is configured so that the operating portion is configured to be displaceable between a first operating position and a second operating position differing from the first operating position. In a case where the operating portion is displaced from the first operating position to the second operating position in the second electric power consumption state, the controller is configured to change the electric power consumption state from the second electric power consumption state to the first electric power consumption state and then from the first electric power consumption state to the second electric power consumption state. In a case where the operating portion is displaced from the second operating position to the first operating position in the second electric power consumption state, the controller is configured to change the electric power consumption state from the second electric power consumption state to the first electric power consumption state.

The component according to the seventh aspect changes the electric power consumption state from the second electric power consumption state to the first electric power consumption state and then from the first electric power consumption state to the second electric power consumption state in a case where the operating portion is displaced from the first operating position to the second operating position. This reduces the electric power consumption.

In accordance with an eighth aspect of the present disclosure, the component according to the seventh aspect is configured so that in a case where the controller changes the electric power consumption state from the second electric power consumption state to the first electric power consumption state and then the operating portion is maintained at the second operating portion for a first predetermined time or longer, the controller is configured to change the electric power consumption state from the first electric power consumption state to the second electric power consumption state.

The component according to the eighth aspect changes from the first electric power consumption state to the second electric power consumption state in a case where the operating portion is maintained at the second operating position for the first predetermined time or longer. This reduces the electric power consumption.

In accordance with a ninth aspect of the present disclosure, the component according to the eighth aspect is configured so that in a case where the operating portion is displaced from the second operating position to the first operating position and then the operating portion is maintained at the first operating position for a second predetermined time or longer after the electric power consumption state is changed from the second electric power consumption state to the first electric power consumption state, the controller is configured to change the electric power consumption state from the first electric power consumption state to the second electric power consumption state.

The component according to the ninth aspect changes from the first electric power consumption state to the second electric power consumption state in a case where the operating portion is maintained at the first operating position for the second predetermined time or longer. This reduces the electric power consumption.

In accordance with a tenth aspect of the present disclosure, the component according to the sixth aspect is configured so that the operating portion is configured to be displaceable between a first operating position and a second operating position differing from the first operating position. In a case where the operating portion is displaced from the second operating position to the first operating position, the controller is configured to change the electric power consumption state from the first electric power consumption state to the second electric power consumption state and maintain the second electric power consumption state until the operating portion is displaced from the first operating position to the second operating position.

The component according to the tenth aspect maintains the second electric power consumption state until the operating portion is displaced from the first operating position to the second operating position. This reduces the electric power consumption.

In accordance with an eleventh aspect of the present disclosure, the component according to any one of the seventh to tenth aspects is configured so that the controller is configured to control the transmitter so that the predetermined signal is transmitted in a case where the electric power consumption state is changed from the second electric power consumption state to the first electric power consumption state.

The component according to the eleventh aspect controls the transmitter to transmit the predetermined signal in a case where the electric power consumption state is changed from the second electric power consumption state to the first electric power consumption state. This transmits the predetermined signal in a preferred manner.

In accordance with a twelfth aspect of the present disclosure, the component according to any one of the eighth to eleventh aspects is configured so that the controller is configured to control the transmitter so that the predetermined signal is transmitted in at least one of a case where the operating portion is displaced from the first operating position to the second operating position and a case where the operating portion is displaced from the second operating position to the first operating position.

The component according to the twelfth aspect controls the transmitter to transmit the predetermined signal in at least one of a case where the operating portion is displaced from the first operating position to the second operating position and a case where the operating portion is displaced from the second operating position to the first operating position. This appropriately transmits the predetermined signal in accordance with the operating state of the operating portion.

In accordance with a thirteenth aspect of the present disclosure, the component according to any one of the first to twelfth aspects is configured so that the controller is configured to control the transmitter so that the predetermined signal is not transmitted in a case where the operating portion is operated and a predetermined condition related to the further component is satisfied. The controller is configured to control the transmitter so that the predetermined signal is transmitted in a case where the operating portion is operated and the predetermined condition is not satisfied.

The component according to the thirteenth aspect does not transmit the predetermined signal in a case where the operating portion is operated and the predetermined condition is satisfied. This reduces the electric power consumption.

A component in accordance with a fourteenth aspect of the present disclosure is for a human-powered vehicle. The component comprises an operating portion configured to be operable by a user, an electric power generator, a transmitter, and a controller. The electric power generator is configured to generate electric power in accordance with displacement of the operating portion in a case where the user operates the operating portion. The transmitter is configured to transmit a predetermined signal to a further component. The controller is configured to be actuated by the electric power generated by the electric power generator. The controller is configured to control the transmitter so that the predetermined signal is not transmitted in a case where the operating portion is operated and a predetermined condition related to the further component is satisfied. The controller is configured to control the transmitter so that the predetermined signal is transmitted in a case where the operating portion is operated and the predetermined condition is not satisfied.

The component according to the fourteenth aspect does not transmit the predetermined signal in a case where the operating portion is operated and the predetermined condition is satisfied. This reduces the electric power consumption. Therefore, the component optimally uses the electric power generated by the electric power generator.

In accordance with a fifteenth aspect of the present disclosure, the component according to the thirteenth or fourteenth aspect is configured so that the further component includes a transmission device configured to shift a transmission ratio of the human-powered vehicle. The predetermined signal includes a shifting instruction that actuates the transmission device to shift the transmission ratio. The predetermined condition is satisfied in a case where the transmission ratio is less than or equal to a first transmission ratio or greater than or equal to a second transmission ratio that is greater than the first transmission ratio.

The component according to the fifteenth aspect does not transmit the predetermined signal in a case where the transmission ratio is less than or equal to the first transmission ratio or greater than or equal to the second transmission ratio, which is greater than the first transmission ratio. This reduces the electric power consumption.

In accordance with a sixteenth aspect of the present disclosure, the component according to the thirteenth or fourteenth aspect is configured so that the further component includes a transmission device configured to shift a transmission ratio of the human-powered vehicle. The transmission device is configured to shift the transmission ratio in stages. The predetermined signal includes a shifting instruction that actuates the transmission device to shift the transmission ratio in accordance with a shifting request. The predetermined condition is satisfied in a case where the shifting request is for shifting the transmission ratio by two or more stages and the transmission ratio shifted by two or more stages in response to the shifting request becomes greater than a maximum transmission ratio or less than a minimum transmission ratio.

The component according to the sixteenth aspect does not transmit the predetermined signal in a case where the shifting request is for shifting the transmission ratio by two or more stages and the transmission ratio shifted by two or more stages in response to the shifting request becomes greater than the maximum transmission ratio or less than the minimum transmission ratio. This reduces the electric power consumption.

In accordance with a seventeenth aspect of the present disclosure, the component according to the sixteenth aspect is configured so that the transmission device is configured to shift the transmission ratio in stages. The controller is configured to control the transmission device so that a moving speed of the transmission device differs between a case where the transmission ratio is shifted by one stage and a case where the transmission ratio is shifted by two or more stages.

The component according to the seventeenth aspect controls the transmission device so that the moving speed of the transmission device differs between a case where the transmission ratio is shifted by one stage and a case where the transmission ratio is shifted by two or more stages. This allows the user to readily recognize the transmission ratio by the moving speed of the transmission device.

In accordance with an eighteenth aspect of the present disclosure, the component according to any one of the first to seventeenth aspects is configured so that the further component includes a first further component and a second further component differing from the first further component. The controller is configured to transmit the predetermined signal differently in a case where the operating portion is operated to actuate the first further component and a case where the operating portion is operated to actuate the second further component.

The component according to the eighteenth aspect transmits the predetermined signal differently in a case where the operating portion is operated to actuate the first further component and a case where the operating portion is operated to actuate the second further component. This transmits the predetermined signal to the first further component and the second further component in a preferred manner.

A component in accordance with a nineteenth aspect of the present disclosure is for a human-powered vehicle. The component comprises an operating portion configured to be operable by a user, an electric power generator, a transmitter, and a controller. The electric power generator is configured to generate electric power in accordance with displacement of the operating portion in a case where the user operates the operating portion. The transmitter is configured to selectively transmit a predetermined signal to a first further component and a second further component differing from the first further component. The controller is configured to be actuated by the electric power generated by the electric power generator. The controller is configured to transmit the predetermined signal differently in a case where the operating portion is operated to actuate the first further component and a case where the operating portion is operated to actuate the second further component.

The component according to the nineteenth aspect transmits the predetermined signal differently in a case where the operating portion is operated to actuate the first further component and a case where the operating portion is operated to actuate the second further component. This transmits the predetermined signal to the first further component and the second further component in a preferred manner. Therefore, the component optimally uses the electric power generated by the electric power generator.

In accordance with a twentieth aspect of the present disclosure, the component according to any one of the first to nineteenth aspects further comprises an operation detector that is separate from the electric power generator, and that is configured to detect the operating state of the operating portion.

The component according to the twentieth aspect detects the operating state of the operating portion with the operating detector in a preferred manner.

In accordance with a twenty-first aspect of the present disclosure, the component according to any one of the first to twentieth aspects is configured so that the electric power generator is configured to generate electric power through magnetostrictive electric power generation.

The component according to the twenty-first aspect includes the electric power generator, which generates electric power through magnetostrictive electric power generation, and uses the generated electric power in a preferred manner.

In accordance with a twenty-second aspect of the present disclosure, the component according to the twenty-first aspect is configured so that the electric power generator includes an oscillating portion and a coil. The oscillating portion is oscillated by displacement of the operating portion and includes a magnetostrictive member. The coil generates electric power through oscillation of the oscillating portion.

With the component according to the twenty-second aspect, the electric power generator generates electric power with the oscillating portion and the coil in a preferred manner.

The human-powered vehicle component according to the present disclosure uses generated electric power in a preferred manner.

### BRIEF DESCRIPTION OF THE DRAWINGS

Referring now to the attached drawings which form a part of this original disclosure, illustrative embodiments are shown.

FIG. 1 is a side elevational view of a human-powered vehicle including a human-powered vehicle component in accordance with a first embodiment.

FIG. 2 is a perspective view of the human-powered vehicle component shown in FIG. 1.

FIG. 3 is a plan view of the human-powered vehicle component shown in FIG. 2 in which the lid has been removed for showing the inside of the human-powered vehicle component.

FIG. 4 is a cross-sectional view of the human-powered vehicle component shown in FIG. 2.

FIG. 5 is a block diagram showing the electrical configuration of the human-powered vehicle shown in FIG. 1.

FIG. 6 is a first part of a flowchart illustrating a process executed by a controller of the human-powered vehicle component shown in FIG. 5 to transmit a predetermined signal.

FIG. 7 is a second part of the flowchart illustrating the process executed by the controller of the human-powered vehicle component shown in FIG. 5 to transmit a predetermined signal.

FIG. 8 is a flowchart illustrating a process executed by a controller of a further component shown in FIG. 5 to perform shifting.

FIG. 9 is a timing diagram illustrating changes over time in different parts of the human-powered vehicle component and the further component in a case where a transmission device performs shifting by one stage.

FIG. 10 is a timing diagram illustrating changes over time in the different parts of the human-powered vehicle component and the further component in a case where the transmission device performs shifting by multiple stages.

FIG. 11 is a first part of a flowchart illustrating a process executed by a controller of the human-powered vehicle component in accordance with a second embodiment to transmit a predetermined signal.

FIG. 12 is a second part of the flowchart illustrating the process executed by the controller of the human-powered vehicle component in accordance with the second embodiment to transmit a predetermined signal.

FIG. 13 is a third part of the flowchart illustrating the process executed by the controller of the human-powered vehicle component in accordance with the second embodiment to transmit a predetermined signal.

FIG. 14 is a flowchart illustrating a process executed by a controller of the human-powered vehicle component in accordance with a third embodiment to transmit a predetermined signal.

FIG. 15 is a flowchart illustrating a process executed by a controller of the human-powered vehicle component in accordance with a fourth embodiment to transmit a predetermined signal.

FIG. 16 is a block diagram showing the configuration of an electric power generator and an electric power storage in accordance with a fifth embodiment.

FIG. 17 is a flowchart illustrating a process executed by a controller of the human-powered vehicle component in accordance with the fifth embodiment to transmit a predetermined signal.

FIG. 18 is a flowchart illustrating a process executed by a controller of the human-powered vehicle component in accordance with a first modification to transmit a predetermined signal.

FIG. 19 is a block diagram showing the configuration of a controller, an electric power generator, and an electric power storage in accordance with a second modification.

FIG. 20 is a schematic diagram showing the structure of a human-powered vehicle component in accordance with a third modification.

FIG. 21 is a schematic diagram showing the structure of the human-powered vehicle component in accordance with the third modification.

### DETAILED DESCRIPTION

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

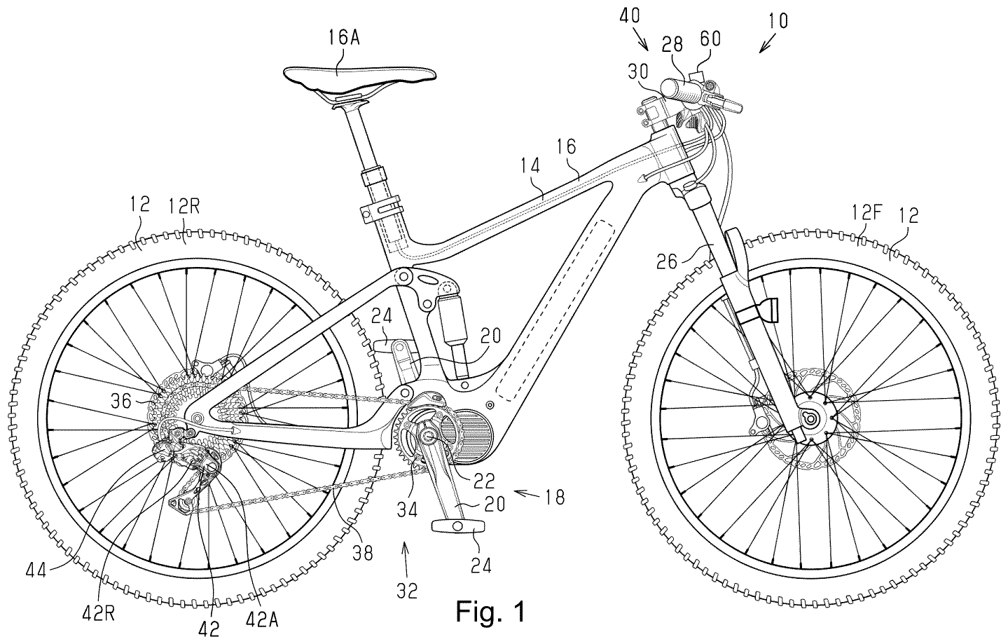

As seen in FIG. 1, a human-powered vehicle is provided with a human-powered vehicle component 60 in accordance with a first embodiment. The human-powered vehicle component 60 in accordance with the first embodiment will now be described with reference to FIGS. 1 to 10. Hereinafter, the human-powered vehicle component 60 will be referred to as the component 60 for the sake of brevity.

A human-powered vehicle is a vehicle that includes at least one wheel and can be driven by at least a human driving force. Examples of the human-powered vehicle include various types of bicycles, such as a mountain bike, a road bike, a city bike, a cargo bike, a handcycle, or a recumbent bike. There is no limit to the number of wheels of the human-powered vehicle. The human-powered vehicle also includes, for example, a unicycle or a vehicle having two or more wheels. The human-powered vehicle is not limited to a vehicle that can be driven only by a human driving force. The human-powered vehicle includes an electric bicycle (E-bike) that uses driving force of an electric motor for propulsion in addition to human driving force. The E-bike includes an electric assist bicycle that assists in propulsion with an electric motor. In each embodiment described hereafter, the human-powered vehicle 10 refers to an electric assist bicycle.

Here, in each embodiment, the human-powered vehicle 10 includes at least one wheel 12 and a vehicle body 14. The at least one wheel 12 includes, for example, a front wheel 12F and a rear wheel 12R. The vehicle body 14 includes a frame 16. For example, a saddle 16A is attached to the frame 16.

The human-powered vehicle 10 further includes, for example, a crank 18 that receives a human driving force. The crank 18 includes, for example, a crank arm 20 and a crank axle 22. The crank axle 22 is, for example, rotatable relative to the frame 16. For example, a pedal 24 is coupled to the crank arm 20. The crank arm 20 is, for example, provided on each axial end of the crank axle 22.

A front fork 26 is connected to the frame 16. The front wheel 12F is attached to the front fork 26. A handlebar 28 is connected to the front fork 26 by a stem 30. The rear wheel 12R is supported by the frame 16. In the present embodiment, the crank 18 is connected to the rear wheel 12R by a drive mechanism 32. The rear wheel 12R is driven by the rotation of the crank axle 22. At least one of the front wheel 12F and the rear wheel 12R can be connected to the crank 18 by the drive mechanism 32.

The drive mechanism 32 includes at least one first rotational body 34 coupled to the crank axle 22. The at least one first rotational body 34 includes, for example, a front sprocket. The at least one first rotational body 34 can include a pulley or a bevel gear. The crank axle 22 can be coupled to the front sprocket by a one-way clutch.

The drive mechanism 32 further includes at least one second rotational body 36 and a transferring member 38. The transferring member 38 is configured to transfer the rotational force of the at least one first rotational body 34 to the at least one second rotational body 36. The transferring member 38 includes, for example, a chain. The transferring member 38 can include a belt or a shaft. The at least one second rotational body 36 includes, for example, a rear sprocket. The at least one second rotational body 36 can include a pulley or a bevel gear. The chain is, for example, wound around the front sprocket and the rear sprocket. The at least one second rotational body 36 is, for example, coupled to the rear wheel 12R. The rear wheel 12R is, for example, configured to rotate as the at least one second rotational body 36 rotates.

The human-powered vehicle 10 includes, for example, a human-powered vehicle control system 40. The control system 40 includes, for example, the component 60 and a further component 42. For example, the component 60 is an operating device for operating the further component 42. The component 60 can also be referred to as a user operable component, or a user operable operating device. The further component 42 is, for example, provided on the vehicle body 14.

The further component 42 includes, for example, a transmission device 42A configured to shift a transmission ratio of the human-powered vehicle 10. The transmission device 42A is, for example, configured to shift the transmission ratio in stages. The transmission device 42A is configured to shift the transmission ratio of the human-powered vehicle 10 in accordance with a shift stage. The transmission ratio of the human-powered vehicle 10 is, for example, a ratio of a rotational speed of the rear wheel 12R to a rotational speed of the crank axle 22. The transmission device 42A is, for example, provided on the frame 16. The transmission device 42A includes, for example, at least one of a rear transmission device 42R and a front transmission device. The transmission device 42A includes, for example, an external transmission device. The transmission device 42A includes, for example, a rear derailleur. The transmission device 42A can include a front derailleur. The transmission device 42A can include an internal transmission device. The internal transmission device is, for example, provided in a hub of the rear wheel 12R. The transmission device 42A can include a continuously variable transmission (CVT).

The transmission device 42A includes, for example, an electric transmission device. The transmission device 42A includes, for example, an actuator 44 operated by electric power. The operation of the actuator 44 shifts the transmission ratio. The actuator 44 includes, for example, an electric motor.

The transmission device 42A includes, for example, a controller 46. In each of the embodiments, the controller 46 can be referred to as an electronic controller 46. The terms “controller” and “electronic controller” as used herein refer to hardware that executes a software program, and does not include a human being. The controller 46 is formed of one or more semiconductor chips that are mounted on a circuit board. The controller 46 includes a processor that executes predetermined control programs. The processor of the controller 46 includes, for example, a central processing unit (CPU) or a micro-processing unit (MPU). The CPU or MPU of the controller 46 can be one or more integrated circuits having firmware for causing the circuitry to execute the predetermined control programs and/or complete the activities described herein. The controller 46 is, for example, configured to control the actuator 44.

The processor of the controller 46 can be, for example, provided at separate locations. In a case where the processor is provided at separate locations, separated parts of the processor can be connected to one another in a manner allowing for communication via a wireless communication device. The controller 46 can include one or more microcomputers.

The further component 42 further includes, for example, a storage 48. The storage 48 can also be referred to as memory or a computer storage device. The storage 48 is any computer storage device (non-transitory computer-readable medium) but does not include a transitory propagating signal. The storage 48 is, for example, connected to the controller 46 in a manner allowing for wired or wireless communication. The storage 48 stores, for example, control programs and information used for control processes. The storage 48 includes, for example, a non-volatile memory and a volatile memory. The non-volatile memory includes, for example, at least one of a read-only memory (ROM), an erasable programmable read-only memory (EPROM), an electrically erasable programmable read-only memory (EEPROM), and a flash memory. The volatile memory includes, for example, a random-access memory (RAM).

The further component 42 further includes, for example, a receiver 50. The receiver 50 is configured to receive a signal from the component 60. The receiver 50 is, for example, configured to receive a signal from the component 60 through wireless communication. The receiver 50 can be configured to receive a signal from the component 60 through wired communication. The further component 42 can further include a transmitter. In a case where the further component 42 includes a transmitter, the transmitter and the receiver 50 can form a single communication unit.

The control system 40 further includes, for example, a battery 52 that supplies electric power to the further component 42. The battery 52 includes one or more battery elements. Each battery cell includes a rechargeable battery. The battery 52 supplies electric power to, for example, at least one of the actuator 44 and the controller 46. The battery 52 can be provided on the further component 42. Alternatively, the battery 52 can be provided on the human-powered vehicle 10 separately from the further component 42.

The human-powered vehicle component 60 includes an operating portion 62 configured to be operable by a user, an electric power generator 64, a transmitter 66, and a controller 68. The component 60 is, for example, attached to the vehicle body 14 at a position manually operable by the user.

In a case where the further component 42 includes the transmission device 42A, the control system 40 can include a first component having the operating portion 62 for increasing the transmission ratio and a second component having the operating portion 62 for decreasing the transmission ratio. In a case where the further component 42 includes the transmission device 42A, the component 60 can include the operating portion 62 for increasing the transmission ratio and the operating portion 62 for decreasing the transmission ratio. In a case where the component 60 includes multiple operating portions 62, the component 60 can include electric power generators 64 that respectively correspond to the operating portions 62.

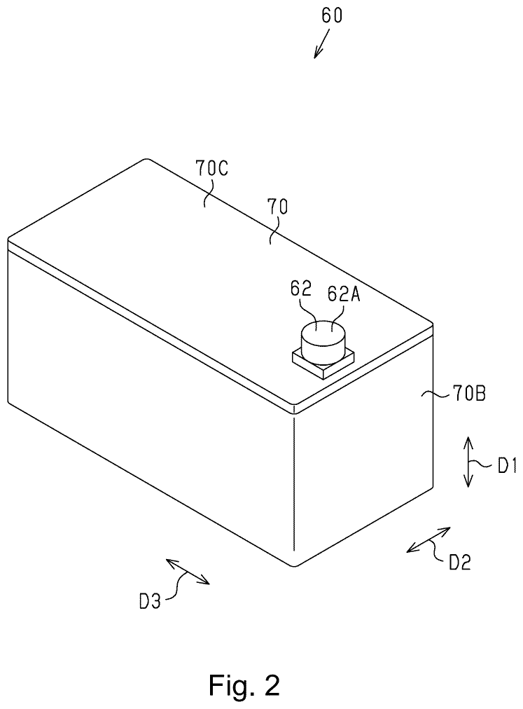

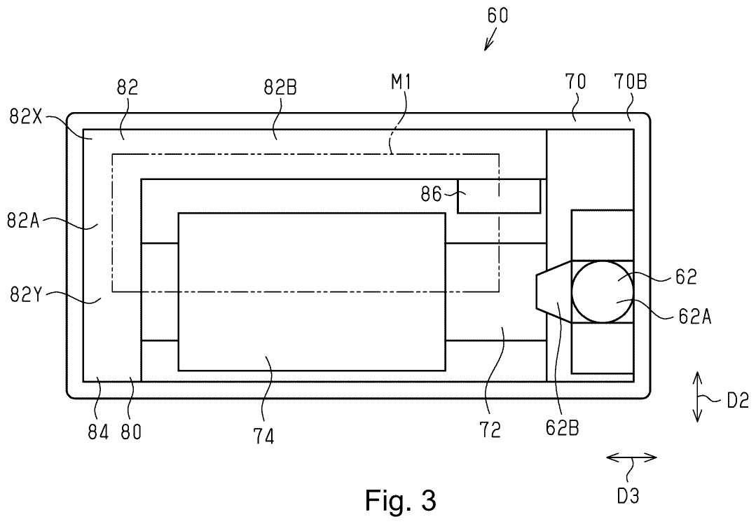

As shown in FIGS. 2 and 3, the component 60 further includes, for example, a housing 70. The housing 70 is, for example, substantially box-shaped. The shape of the housing 70 can be changed as needed and/or desired. In a case where the component 60 includes multiple operating portions 62, the operating portions 62 can be provided on a single housing 70. Alternatively, the operating portions 62 can be provided on separate housings 70.

The housing 70 is, for example, attached to the handlebar 28 shown in FIG. 1. The housing 70 is, for example, coupled to the handlebar 28 by a clamp (not shown). The housing 70 can be attached to the frame 16 or a portion of the human-powered vehicle 10 in the vicinity of the handlebar 28. The housing 70 can be at least partially incorporated in the frame 16. The housing 70 can be provided in an additional housing that differs from the housing 70. In a case where the housing 70 is provided in the additional housing, the additional housing can accommodate multiple components 60.

As shown in FIGS. 2 to 4, for example, the housing 70 includes a bottom 70A, a wall 70B, and a lid 70C. For example, the bottom 70A and the wall 70B are formed integrally with each other. The lid 70C can be formed integrally with the bottom 70A and the wall 70B. Alternatively, the lid 70C can be formed separately from the bottom 70A and the wall 70B. The lid 70C includes, for example, a first through hole 70X that receives the operating portion 62.

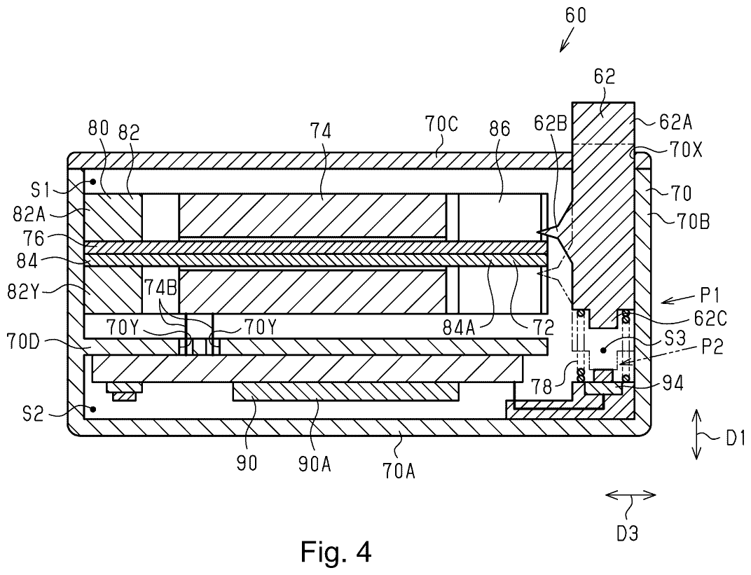

As shown in FIG. 4, for example, the housing 70 includes a dividing wall 70D. The dividing wall 70D is located between the bottom 70A and the lid 70C. The dividing wall 70D includes, for example, at least one second through hole 70Y. In the present embodiment, the dividing wall 70D includes two second through holes 70Y.

In an example, a first cavity S1, a second cavity S2, and a third cavity S3 are defined inside the housing 70. The first cavity S1 is defined between the lid 70C and the dividing wall 70D. The second cavity S2 is defined between the bottom 70A and the dividing wall 70D. The third cavity S3 is defined inside the housing 70 where the dividing wall 70D does not extend. The third cavity S3 is defined between the bottom 70A and the lid 70C. The first cavity S1 is continuous with the second cavity S2 through the third cavity S3.

The operating portion 62 is, for example, at least partially exposed from the housing 70. The operating portion 62 is, for example, inserted into the first through hole 70X of the lid 70C. The operating portion 62 includes, for example, a first part 62A. The first part 62A includes, for example, a portion located outside the housing 70. The operating portion 62 includes, for example, a second part 62B. The second part 62B is, for example, configured to contact the electric power generator 64. For example, the operating portion 62 extends in a first direction D1. The operating portion 62 is, for example, post-shaped. The first part 62A is, for example, provided at one end of the operating portion 62 in the first direction D1. The operating portion 62 includes, for example, a third part 62C. The third part 62C is, for example, provided at the other end of the operating portion 62 in the first direction D1. The second part 62B is, for example, provided on a projection projecting in a direction intersecting the first direction D1.

The operating portion 62 is, for example, configured to be displaceable between a first operating position P1 and a second operating position P2 differing from the first operating position P1. The operating portion 62 is, for example, at least partially arranged in the third cavity S3. The operating portion 62 is arranged in the first through hole 70X such that the first part 62A is located outside the housing 70. The first part 62A is arranged on the housing 70 in a manner movable in the first direction D1. For example, the operating portion 62 is moved in the first direction D1 as the user operates the first part 62A. In a case where the user pushes the first part 62A, the operating portion 62 is moved in a direction extending from the lid 70C toward the bottom 70A. The operating portion 62 can be configured to move in the first direction D1 in a case where the user pulls the first part 62A. In a case where the operating portion 62 is configured to move in the first direction D1 as the user pulls the first part 62A, for example, the first operating position P1 corresponds to the second operating position P2 shown in FIG. 4 and the second operating position P2 corresponds to the first operating position P1 shown in FIG. 4.

The component 60 includes, for example, a biasing member 78. The biasing member 78 is, for example, configured to bias the operating portion 62 from the bottom 70A toward the lid 70C. In a case where the first part 62A is not being pushed by the user, for example, the biasing member 78 biases the operating portion 62 such that the first part 62A of the operating portion 62 is exposed from the housing 70 as shown in FIG. 4. The biasing member 78 includes, for example, a coil spring. In a case where the user pushes the first part 62A such that the operating portion 62 is moved in a direction extending from the lid 70C toward the bottom 70A and then the user removes his/her hand from the first part 62A, the biasing member 78 moves the operating portion 62 from the bottom 70A toward the lid 70C.

The first operating position P1 is, for example, a position of the operating portion 62 in a state in which no external force is applied to the operating portion 62. The first operating position P1 is, for example, determined by the biasing force of the biasing member 78. The second operating position P2 includes, for example, a position of the operating portion 62 at which the third part 62C of the operating portion 62 is closest to the bottom 70A in the movable range of the operating portion 62. The second operating position P2 includes, for example, at least part of a position of the operating portion 62 at which the second part 62B of the operating portion 62 is closer to the bottom 70A than to an oscillating portion 72 of the electric power generator 64. The second operating position P2 includes, for example, an entirety of a position of the operating portion 62 at which the second part 62B of the operating portion 62 is closer to the bottom 70A than to the oscillating portion 72 of the electric power generator 64.

The electric power generator 64 is, for example, configured to generate electric power in accordance with displacement of the operating portion 62 in a case where the user operates the operating portion 62. The electric power generator 64 is, for example, configured to generate electric power through magnetostrictive electric power generation. The electric power generator 64 is, for example, a vibration electric power generator that uses the inverse magnetostrictive effect. The electric power generator 64 includes, for example, the oscillating portion 72 and a coil 74. The oscillating portion 72 is, for example, oscillated by displacement of the operating portion 62 and includes a magnetostrictive member 76. For example, the coil 74 generates electric power through oscillation of the oscillating portion 72. The electric power generation time length of the electric power generator 64 is dependent on the vibration time length of the oscillating portion 72 determined by the movement speed of the operating portion 62, force applied to the oscillating portion 72 by the operating portion 62, structure of the oscillating portion 72, or the like.

The electric power generator 64 is, for example, arranged in the first cavity S1. The electric power generator 64 includes a support member 80 that supports the magnetostrictive member 76. The support member 80 includes, for example, a yoke 82. The yoke 82 is, for example, secured to the housing 70. The yoke 82 supports, for example, the magnetostrictive member 76. The yoke 82 is at least partially formed from a magnetic material. In the present embodiment, the yoke 82 is entirely formed from a magnetic material. The magnetic material is, for example, soft magnetic steel. The magnetic material can be, for example, SS400, which is a type of soft magnetic steel. The yoke 82 includes, for example, a first yoke part 82A and a second yoke part 82B continuous with the first yoke part 82A.

In an example, the first yoke part 82A extends in a second direction D2. The second direction D2 intersects, for example, the first direction D1. The second direction D2 is, for example, orthogonal to the first direction D1. The first yoke part 82A is, for example, secured to the wall 70B. The first yoke part 82A includes, for example, a connecting part 82X. The connecting part 82X is, for example, connected to the second yoke part 82B. The second yoke part 82B extends, for example, in a third direction D3. The third direction D3 intersects, for example, each of the first direction D1 and the second direction D2. The third direction D3 is, for example, orthogonal to each of the first direction D1 and the second direction D2. One end of the second yoke part 82B is connected to the connecting part 82X of the first yoke part 82A. The first yoke part 82A includes, for example, a support part 82Y. The support part 82Y supports the magnetostrictive member 76.

The yoke 82 includes, for example, yoke plates. The support member 80 further includes, for example, a support frame 84. At least part of the support frame 84 is disposed between the yoke plates. The support frame 84 includes, for example, a non-magnetic material. The support frame 84 is, for example, at least partially formed from a non-magnetic material. The support frame 84 is, for example, entirely formed from a non-magnetic material. The support frame 84 is formed from, for example, stainless steel. The support frame 84 can include a magnetic material. The support frame 84 can have a non-magnetic property as a whole.

The support frame 84 includes a portion disposed between the yoke plates of the first yoke part 82A, and a seat 84A exposed from the first yoke part 82A. The seat 84A extends from the first yoke part 82A in the third direction D3.

The magnetostrictive member 76 is formed from a magnetostrictive material and is configured to be oscillated in the first direction D1. The magnetostrictive material is, for example, a Fe—Ga alloy. The magnetostrictive member 76 has a permeability that changes in accordance with expansion and contraction of the magnetostrictive member 76. The magnetostrictive member 76 has a magnetization direction that changes in accordance with expansion and contraction of the magnetostrictive member 76. The magnetostrictive member 76 is, for example, configured to be oscillated relative to the housing 70 in the first direction D1.

The magnetostrictive member 76 is, for example, plate-shaped and extends in the third direction D3. One end of the magnetostrictive member 76 in the third direction D3 is disposed in the first yoke part 82A. The magnetostrictive member 76 is, for example, attached to the seat 84A of the support frame 84. The magnetostrictive member 76 is, for example, attached to the seat 84A by an adhesive.

The support frame 84 is, for example, elastically deformable. The support frame 84 is, for example, configured to be oscillated in the first direction D1 in a case where the support frame 84 is elastically deformed in the first direction D1 about the portion disposed in the first yoke part 82A. The magnetostrictive member 76 is oscillated in the first direction D1, for example, together with the seat 84A.

The coil 74 generates electric power through the oscillation of the magnetostrictive member 76 in the first direction D1. The coil 74 is, for example, wound around at least one of the magnetostrictive member 76 and the seat 84A. In the present embodiment, the coil 74 is wound around both the magnetostrictive member 76 and the seat 84A.

As shown in FIG. 3, for example, the electric power generator 64 includes a magnetic flux forming member 86. In the present embodiment, the magnetostrictive member 76 and the yoke 82 form a closed magnetic circuit M1. The magnetic flux forming member 86 is disposed between the yoke 82 and the magnetostrictive member 76 in the second direction D2 to allow passage of the magnetic flux of the closed magnetic circuit M1. The magnetic flux forming member 86 increases the density of the magnetic flux extending through the magnetostrictive member 76, thereby increasing the voltage of the electric power generated by the electric power generator 64. The magnetic flux forming member 86 includes, for example, a magnet.

As shown in FIG. 4, the operating portion 62 is provided in the housing 70 in a manner allowing for contact between the second part 62B and at least one of the magnetostrictive member 76 and the seat 84A. For example, the second part 62B is a projection that overlaps at least one of the magnetostrictive member 76 and the seat 84A as viewed in the first direction D1. In the present embodiment, the second part 62B is disposed to overlap both the magnetostrictive member 76 and the seat 84A as viewed in the first direction D1. The second part 62B is, for example, configured to contact at least one of the magnetostrictive member 76 and the seat 84A in the first direction D1.

The second part 62B is, for example, configured to induce oscillation of at least one of the magnetostrictive member 76 and the seat 84A in the electric power generator 64 as the user operates the first part 62A of the operating portion 62.

In a case where the user pushes the first part 62A in a state in which the operating portion 62 is located at the first operating position P1, the operating portion 62 is moved from the first operating position P1 toward the second operating position P2. The second part 62B pushes, for example, at least one of the magnetostrictive member 76 and the seat 84A in correspondence with the movement of the operating portion 62. The pushing of at least one of the magnetostrictive member 76 and the seat 84A by the second part 62B moves the at least one of the magnetostrictive member 76 and the seat 84A in the first direction D1. In a case where at least one of the magnetostrictive member 76 and the seat 84A is moved in the first direction D1, the at least one of the magnetostrictive member 76 and the seat 84A moves about a portion where the at least one of the magnetostrictive member 76 and the seat 84A is disposed in the first yoke part 82A. As the second part 62B is further moved in the first direction D1 and passes a portion corresponding to the magnetostrictive member 76 and the seat 84A, for example, the magnetostrictive member 76 and the seat 84A are oscillated. The magnetostrictive member 76 expands and contracts with the oscillation, which, in turn, changes the magnetic flux passing through the coil 74. This change in the magnetic flux passing through the coil 74 causes the coil 74 to generate electric power.

In a case where the user removes his/her hand from the first part 62A in a state in which the operating portion 62 is located at the second operating position P2, the biasing member 78 biases the operating portion 62 such that the operating portion 62 is moved toward the first operating position P1. As the second part 62B passes the portion corresponding to the magnetostrictive member 76 and the seat 84A, the magnetostrictive member 76 and the seat 84A are oscillated. The magnetostrictive member 76 expands and contracts with the oscillation, which, in turn, changes the magnetic flux passing through the coil 74. This change in the magnetic flux passing through the coil 74 causes the coil 74 to generate electric power.

The component 60 includes, for example, an electric power storage 88. The electric power storage 88 is, for example, provided on a circuit unit 90. The electric power generated by the electric power generator 64 is supplied to, for example, the electric power storage 88. The electric power storage 88 includes, for example, a capacitor. Instead of or in addition to the capacitor, the electric power storage 88 can include a battery.

Two coil lead wires 74B are drawn from the coil 74. The coil lead wires 74B electrically connect the coil 74 and the electric power storage 88. The two coil lead wires 74B are respectively continuous with the two ends of the coil wire that forms the coil 74. The coil lead wires 74B extend through the second through holes 70Y of the dividing wall 70D from the first cavity S1 to the second cavity S2.

The component 60 includes, for example, the circuit unit 90. The circuit unit 90 is, for example, disposed in the second cavity S2. The circuit unit 90 includes, for example, an electrical substrate 90A. The electrical substrate 90A is, for example, plate-shaped and extends in a direction orthogonal to the first direction D1. The electrical substrate 90A is, for example, secured to the dividing wall 70D.

In each of the embodiments, the controller 68 can be referred to as an electronic controller 68. The controller 68 is, for example, mounted on the electrical substrate 90A. The controller 68 includes a processor that executes predetermined control programs. The processor includes, for example, a CPU or an MPU. The CPU or MPU of the controller 68 can be one or more integrated circuits having firmware for causing the circuitry to execute the predetermined control programs and/or complete the activities described herein. The controller 68 can include one or more microcomputers. The controller 68 can include a plurality of processors located at separate positions. The controller 68 is, for example, actuated by the electric power supplied from the electric power storage 88.

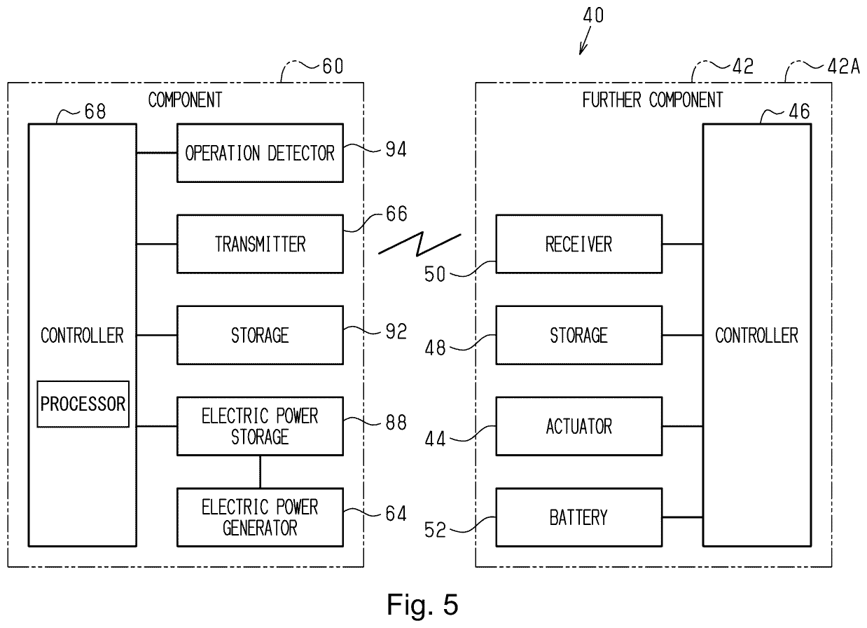

As shown in FIG. 5, the component 60 includes, for example, a storage 92. The storage 92 is, for example, mounted on the electrical substrate 90A. The storage 92 can also be referred to as memory or a computer storage device. The storage 92 is any computer storage device (non-transitory computer-readable medium) but does not include a transitory propagating signal. The storage 92 includes, for example, a non-volatile memory and a volatile memory.

The transmitter 66 is, for example, mounted on the electrical substrate 90A. The transmitter 66 is configured to transmit a predetermined signal to the further component 42. The transmitter 66 is configured to transmit a predetermined signal to the further component 42 with the electric power generated by the electric power generator 64. The transmitter 66 includes, for example, a wireless transmitter. The wireless transmitter is, for example, configured to output an operation signal to the further component 42. The communication protocol used by the wireless transmitter and the further component 42 is not particularly limited, and can include near-range wireless communication, such as Bluetooth®, Bluetooth Low Energy® (BLE), near-field communication (NFC), ANT®, or the like.

The component 60 further includes, for example, an operation detector 94 that is separate from the electric power generator 64, and is configured to detect an operating state of the operating portion 62. The term “detector” as used herein refers to a hardware device or instrument designed to detect the presence or absence of a particular event, object, substance, or a change in its environment, and to emit a signal in response. The term “detector” as used herein refers to hardware and does not include a human being. The operation detector 94 is, for example, disposed in the third cavity S3 between the operating portion 62 and the bottom 70A. The operation detector 94 includes, for example, an element that consumes electric power. The operation detector 94 includes, for example, a tact switch configured to be pushed in correspondence with the operation of the operating portion 62. The operation detector 94 is, for example, electrically connected to the controller 68. The operation detector 94 is, for example, actuated by the electric power supplied from the electric power storage 88. The electric power of the electric power storage 88 can be supplied to the operation detector 94 via the controller 68.

The operation detector 94 outputs, for example, a detection signal to the circuit unit 90 in response to the movement of the operating portion 62. The operation detector 94 is, for example, configured to transmit a detection signal to the controller 68 in a case where the operating portion 62 is located at the second operating position P2. The detection signal is, for example, an ON signal. In a case where the detection signal is an ON signal, for example, the operation detector 94 is configured to not be electrically connected to the controller 68 in a state in which the operating portion 62 is located at the first operating position P1 and be electrically connected to the controller 68 in a state in which the operating portion 62 is located at the second operating position P2.

The detection signal can be, for example, an OFF signal. In a case where the detection signal is an OFF signal, for example, the operation detector 94 is configured to be electrically connected to the controller 68 in a state in which the operating portion 62 is located at the first operating position P1 and not be electrically connected to the controller 68 in a state in which the operating portion 62 is located at the second operating position P2.

The controller 68 is, for example, configured to control the transmitter 66 so that the predetermined signal is transmitted in response to operation of the operating portion 62. The controller 68 is, for example, configured to control the transmitter 66 to change a transmission state of the predetermined signal in accordance with the operating state of the operating portion 62 in a case where the operating portion 62 is operated. The predetermined signal includes, for example, an actuation instruction for actuating the further component 42. In a case where the further component 42 includes the transmission device 42A, for example, the predetermined signal includes a shifting instruction that actuates the transmission device 42A to shift the transmission ratio. In a case where the further component 42 includes the transmission device 42A and the operating portion 62 is for increasing the transmission ratio, for example, the predetermined signal includes a first shifting instruction that increases the transmission ratio. In a case where the further component 42 includes the transmission device 42A and the operating portion 62 is for decreasing the transmission ratio, for example, the predetermined signal includes a second shifting instruction that decreases the transmission ratio.

The transmission state includes, for example, a first transmission state and a second transmission state. For example, the transmitter 66 is configured to consume less electric power in the second transmission state than in the first transmission state. In the first transmission state, for example, the transmitter 66 transmits the predetermined signal to the further component 42. In the first transmission state, for example, the transmitter 66 can cyclically transmit an actuation instruction to the further component 42. In the second transmission state, for example, the transmitter 66 does not transmit the predetermined signal to the further component 42. In the second transmission state, for example, the transmitter 66 does not transmit any signal to the further component 42. In the second transmission state, the transmitter 66 does not transmit the predetermined signal and can cyclically transmit a signal other than the predetermined signal at a frequency lower than the transmission frequency of the predetermined signal in the first transmission state. The signal other than the predetermined signal includes, for example, a signal used by the component 60 to check the activation state of the further component 42 or a signal for establishing a communication state between the further component 42 and the component 60.

The controller 68 is, for example, configured to control the transmitter 66 so that the transmission state is maintained in the second transmission state in a case where the operating portion 62 is at the first operating position P1. The controller 68 is, for example, configured to control the transmitter 66 so that the predetermined signal is transmitted in at least one of a case where the operating portion 62 is displaced from the first operating position P1 to the second operating position P2 and a case where the operating portion 62 is displaced from the second operating position P2 to the first operating position P1. In the present embodiment, for example, the controller 68 is configured to control the transmitter 66 so that the predetermined signal is transmitted in both of a case where the operating portion 62 is displaced from the first operating position P1 to the second operating position P2 and a case where the operating portion 62 is displaced from the second operating position P2 to the first operating position P1.

The predetermined signal includes, for example, a first predetermined signal and a second predetermined signal. For example, the first predetermined signal is for operating the actuator 44 of the further component 42. For example, the second predetermined signal is for stopping the actuator 44 of the further component 42. The first predetermined signal can be the same as or differ from the second predetermined signal. In a case where the first predetermined signal is the same as the second predetermined signal, for example, the controller 46 of the further component 42 can determine whether the predetermined signal received by the receiver 50 corresponds to the first predetermined signal or the second predetermined signal.

The controller 68 is, for example, configured to control the transmitter 66 so that the transmission state becomes the first transmission state in a case where the operating portion 62 is displaced from the first operating position P1 to the second operating position P2. The controller 68 is, for example, configured to control the transmitter 66 so that the predetermined signal is transmitted in a case where the operating portion 62 is displaced from the first operating position P1 to the second operating position P2. The controller 68 is, for example, configured to control the transmitter 66 so that the first transmission state, in which the predetermined signal is transmitted, is set in a case where the operating portion 62 is displaced from the first operating position P1 to the second operating position P2. The controller 68 is, for example, configured to control the transmitter 66 so that transmission of the predetermined signal is continued over a first transmission period T1 in a case where the operating portion 62 is displaced from the first operating position P1 to the second operating position P2.

The controller 68 is, for example, configured to control the transmitter 66 so that the transmission state is maintained in the second transmission state while the operating portion 62 is maintained at the second operating position P2 after the operating portion 62 is displaced from the first operating position P1 to the second operating position P2. The controller 68 is, for example, configured to control the transmitter 66 so that the predetermined signal is not transmitted while the operating portion 62 is maintained at the second operating position P2 after the operating portion 62 is displaced from the first operating position P1 to the second operating position P2.

The controller 68 is, for example, configured to control the transmitter 66 so that the transmission state becomes the first transmission state in a case where the operating portion 62 is displaced from the second operating position P2 to the first operating position P1. The controller 68 is, for example, configured to control the transmitter 66 so that the predetermined signal is transmitted in a case where the operating portion 62 is displaced from the second operating position P2 to the first operating position P1. The controller 68 is, for example, configured to control the transmitter 66 so that transmission of the predetermined signal is continued over a second transmission period T2 in a case where the operating portion 62 is displaced from the second operating position P2 to the first operating position P1. The second transmission period T2 can be the same as or differ from the first transmission period T1.

The controller 46 of the further component 42 is, for example, configured to operate the actuator 44 as the receiver 50 receives the predetermined signal. In a case where the predetermined signal includes a shifting instruction, the controller 46 of the further component 42 is configured to operate the actuator 44 so that the transmission ratio is shifted as the receiver 50 receives the predetermined signal.

In an example, the controller 46 of the further component 42 operates the actuator 44 as the receiver 50 receives the first predetermined signal. In a case where the receiver 50 receives the second predetermined signal after the actuator 44 is operated, for example, the controller 46 of the further component 42 is configured to control the actuator 44 so as to stop the actuator 44.

In a case where the predetermined signal includes a shifting instruction, for example, the controller 46 of the further component 42 changes the number of shift stages by which the transmission ratio is shifted based on a period from receipt of the first predetermined signal to receipt of the second predetermined signal. In a case where the predetermined signal includes the first shifting instruction, for example, the controller 46 of the further component 42 is configured to control the actuator 44 so that the transmission ratio is continuously incremented by one stage from receipt of the first predetermined signal until receipt of the second predetermined signal. In a case where the predetermined signal includes the second shifting instruction, for example, the controller 46 of the further component 42 is configured to control the actuator 44 so that the transmission ratio is continuously decremented by one stage from receipt of the first predetermined signal until receipt of the second predetermined signal.

In a case where the second predetermined signal is received while the transmission ratio is being shifted by one stage, for example, the controller 46 of the further component 42 controls the actuator 44 to stop the actuator 44 after completing the shifting of the transmission ratio.

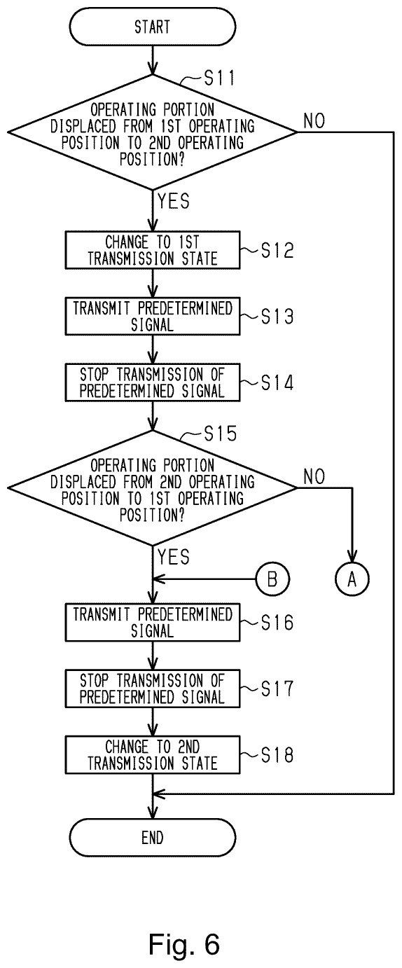

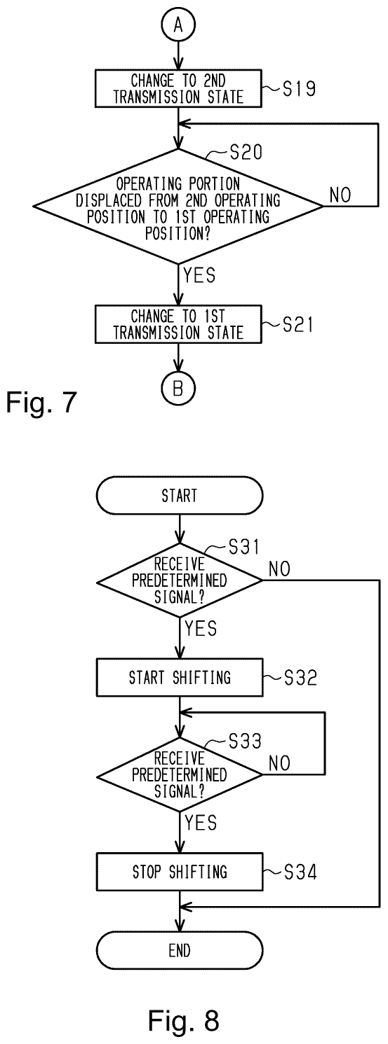

A process executed by the controller 68 to transmit the predetermined signal will now be described with reference to FIGS. 6 and 7. In a case where electric power is supplied to the controller 68, for example, the controller 68 starts the process of the flowchart shown in FIG. 6 from step S11. In a case where the process of the flowcharts shown in FIGS. 6 and 7 ends, for example, the controller 68 repeats the process from step S11 in predetermined cycles until the supply of electric power is stopped.

In step S11, the controller 68 determines whether the operating portion 62 is displaced from the first operating position P1 to the second operating position P2. For example, the controller 68 determines that the operating portion 62 is displaced from the first operating position P1 to the second operating position P2 based on the output of the operation detector 94. For example, the controller 68 determines that the operating portion 62 is displaced from the first operating position P1 to the second operating position P2 in a case where the controller 68 receives a detection signal from the operation detector 94. In a case where the operating portion 62 is not displaced from the first operating position P1 to the second operating position P2, the controller 68 ends the process shown in FIGS. 6 and 7. For example, a case where the operating portion 62 is not displaced from the first operating position P1 to the second operating position P2 is a case where the operating portion 62 is maintained at the first operating position P1. In a case where the operating portion 62 is displaced from the first operating position P1 to the second operating position P2, the controller 68 proceeds to step S12.

In step S12, the controller 68 sets the transmission state to the first transmission state, and then proceeds to step S13. The controller 68 changes the transmission state from the second transmission state to the first transmission state in step S12. In step S13, the controller 68 controls the transmitter 66 to transmit the predetermined signal, and then proceeds to step S14. For example, the controller 68 causes the transmitter 66 to transmit the first predetermined signal in step S13. In step S14, the controller 68 controls the transmitter 66 to stop the transmission of the predetermined signal, and then proceeds to step S15. The period from the initiation of the transmission of the predetermined signal in step S13 until the termination of the transmission of the predetermined signal in step S14 corresponds to the first transmission period T1.

In step S15, the controller 68 determines whether the operating portion 62 is displaced from the second operating position P2 to the first operating position P1. For example, the controller 68 determines that the operating portion 62 is displaced from the second operating position P2 to the first operating position P1 based on the output from the operation detector 94. For example, the controller 68 determines that the operating portion 62 is displaced from the second operating position P2 to the first operating position P1 in a case where the controller 68 stops receiving the detection signal from the operation detector 94. In a case where the operating portion 62 is displaced from the second operating position P2 to the first operating position P1, the controller 68 proceeds to step S16.

In step S16, the controller 68 controls the transmitter 66 to transmit the predetermined signal, and then proceeds to step S17. For example, the controller 68 causes the transmitter 66 to transmit the second predetermined signal in step S16. In step S17, the controller 68 controls the transmitter 66 to stop the transmission of the predetermined signal, and then proceeds to step S18. In step S18, the controller 68 changes the transmission state to the second transmission state, and then ends the process shown in FIGS. 6 and 7. The period from the initiation of the transmission of the predetermined signal in step S16 until the termination of the transmission of the predetermined signal in step S17 corresponds to the second transmission period T2.

In a case where the operating portion 62 is not displaced from the second operating position P2 to the first operating position P1 in step S15, the controller 68 proceeds to step S19. In step S19, the controller 68 changes from the first transmission state to the second transmission state, and then proceeds to step S20. In step S20, the controller 68 determines whether the operating portion 62 is displaced from the second operating position P2 to the first operating position P1. The controller 68 repeats step S20 until the operating portion 62 is displaced from the second operating position P2 to the first operating position P1. In a case where the operating portion 62 is displaced from the second operating position P2 to the first operating position P1, the controller 68 proceeds to step S21. In step S21, the controller 68 changes from the second transmission state to the first transmission state, and then proceeds to step S16.

As long as the operating portion 62 is maintained at the second operating position P2 after the termination of the transmission of the first predetermined signal in step S14, the transmission state is maintained at the second transmission state until the operating portion 62 is displaced from the second operating position P2 to the first operating position P1. In a case where the operating portion 62 is displaced from the second operating position P2 to the first operating position P1 after the termination of the transmission of the first predetermined signal in step S14 and before step S15 is executed, the controller 68 does not have to change the transmission state from the first transmission state to the second transmission state and can maintain the transmission state in the first transmission state.

A process executed by the controller 46 of the further component 42 in response to receipt of the predetermined signal will now be described with reference to FIG. 8. In a case where electric power is supplied to the controller 46, for example, the controller 46 starts the process of the flowchart shown in FIG. 8 from step S31. In a case where the process of the flowchart shown in FIG. 8 ends, for example, the controller 46 repeats the process from step S31 in predetermined cycles until the supply of electric power is stopped.

In step S31, the controller 46 determines whether the predetermined signal is received. For example, the controller 46 determines that the predetermined signal is received in step S31 in a case where the first predetermined signal is received. In a case where the controller 46 does not receive the predetermined signal, the controller 46 ends the process shown in FIG. 8. In a case where the controller 46 receives the predetermined signal, the controller 46 proceeds to step S32.

In step S32, the controller 46 starts shifting, and then proceeds to step S33. The controller 46 starts operation of the actuator 44 in step S32. In step S33, the controller 46 determines whether the predetermined signal is received. For example, the controller 46 determines that the predetermined signal is received in step S33 in a case where the second predetermined signal is received. In a case where the controller 46 does not receive the predetermined signal, the controller 46 repeats step S33. From step S32, the controller 46 continuously shifts the transmission ratio by one stage until the predetermined signal is received.

In a case where the controller 46 receives the predetermined signal in step S33, the controller 46 proceeds to step S34. In step S34, the controller 46 stops shifting, and then ends the process shown in FIG. 8. For example, in step S34, the controller 46 stops the actuator 44 after completing the shifting that was being performed at the time point at which the predetermined signal was received.

The controller 46 can determine the number of shift stages by which the transmission ratio is shifted based on the time length from the receipt of the first predetermined signal in step S33 to the receipt of the second predetermined signal in step S34. The controller 46 stops the actuator 44, for example, upon completion of the shifting of the transmission ratio by the number of shift stages determined based on the time from the receipt of the first predetermined signal to the receipt of the second predetermined signal.

In a case where a stopping condition is satisfied after the initiation of shifting, the controller 46 can be configured to stop the shifting even before the second predetermined signal is received. The stopping condition is satisfied, for example, in a case where the transmission ratio reaches the maximum transmission ratio or the minimum transmission ratio obtainable by the transmission device 42A. In a case where the controller 46 receives the first predetermined signal including the first shifting instruction in step S31 and the present transmission ratio is the maximum transmission ratio, the controller 46 can be configured to end the process shown in FIG. 8 without initiating shifting. In a case where the controller 46 receives the first predetermined signal including the second shifting instruction in step S31 and the present transmission ratio is the minimum transmission ratio, the controller 46 can be configured to end the process shown in FIG. 8 without performing shifting.

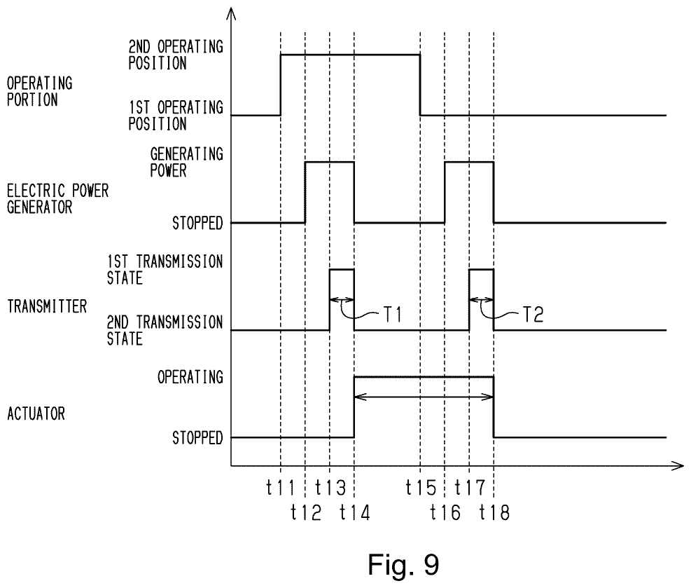

FIG. 9 shows changes in the states of different parts of the component 60 and the further component 42 in a case where the operating portion 62 is operated to shift the transmission ratio by one stage.

Time t11 indicates a time at which the operating portion 62 begins to be displaced from the first operating position P1 to the second operating position P2. At time t11, the electric power generator 64 is not operating. At time t11, the transmission state of the transmitter 66 is the second transmission state.

Time t12 indicates a time at which the electric power generator 64 starts electric power generation in accordance with the displacement of the operating portion 62. For example, time t12 is a time at which the oscillating portion 72 begins to be oscillated as the second part 62B of the operating portion 62 flicks the oscillating portion 72.

Time t13 indicates a time at which the transmission state of the transmitter 66 is changed from the second transmission state to the first transmission state. The transmitter 66 starts transmitting the first predetermined signal at time t13.

Time t14 indicates a time at which the transmitter 66 stops transmitting the first predetermined signal as the first transmission period T1 elapses from time t13. At time t14, the transmission state of the transmitter 66 is changed from the first transmission state to the second transmission state. At time t14 or later, the controller 46 of the further component 42 starts operation of the actuator 44 in response to receipt of the first predetermined signal. In a case where the further component 42 includes the transmission device 42A, shifting of the transmission ratio is initiated at time t14.

Time t15 indicates a time at which the operating portion 62 begins to be displaced from the second operating position P2 to the first operating position P1. For example, time t15 is a time at which the user removes his/her hand from the operating portion 62. As the user removes his/her hand from the operating portion 62, the biasing force of the biasing member 78 returns the operating portion 62 from the second operating position P2 toward the first operating position P1. Time t15 is a time at which the further component 42 is performing shifting to the adjacent stage for the first time.

Time t16 indicates a time at which the electric power generator 64 starts electric power generation in accordance with the displacement of the operating portion 62. For example, time t16 is a time at which the oscillating portion 72 begins to be oscillated as the second part 62B of the operating portion 62 flicks the oscillating portion 72.

Time t17 indicates a time at which the transmission state of the transmitter 66 is changed from the second transmission state to the first transmission state. The transmitter 66 starts transmitting the second predetermined signal at time t17.

Time t18 indicates a time at which the transmitter 66 stops transmitting the second predetermined signal as the second transmission period T2 elapses from time t17. At time t18, the transmission state of the transmitter 66 is changed from the first transmission state to the second transmission state. At time t18 or later, the controller 46 of the further component 42 stops operation of the actuator 44 in response to receipt of the second predetermined signal. In a case where the further component 42 includes the transmission device 42A, the shifting of the transmission ratio is ended at time t18. In FIG. 9, at a time point at which the receiver 50 of the further component 42 receives the second predetermined signal, the first shifting to the adjacent stage is being performed. Therefore, the controller 46 of the further component 42 stops the actuator 44 upon completion of the first shifting to the adjacent stage.

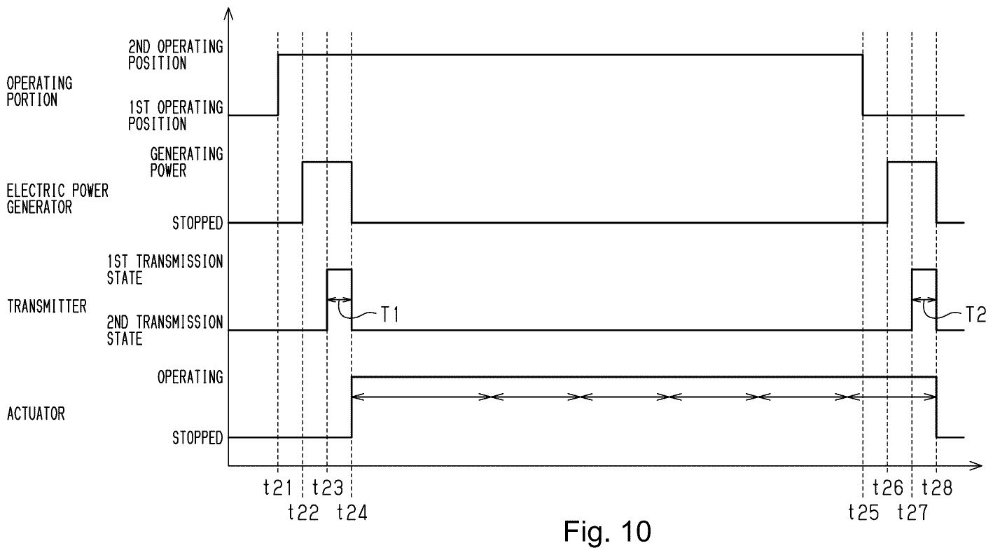

FIG. 10 shows changes in the states of the different parts of the component 60 and the further component 42 in a case where the operating portion 62 is operated to shift the transmission ratio by two or more stages. Times t21, t22, t23, and t24 in FIG. 10 are the same as times t11, t12, t13, and t14 in FIG. 9.

Time t25 indicates a time at which the operating portion 62 begins to be displaced from the second operating position P2 to the first operating position P1. Time t25 is, for example, a time at which the user removes his/her hand from the operating portion 62. As the user removes his/her hand from the operating portion 62, the biasing force of the biasing member 78 returns the operating portion 62 from the second operating position P2 toward the first operating position P1. Time t25 is a time at which the further component 42 is performing shifting to the adjacent stage for the sixth time.

Time t26 indicates a time at which the electric power generator 64 starts electric power generation in accordance with the displacement of the operating portion 62. For example, time t26 is a time at which the oscillating portion 72 begins to be oscillated as the second part 62B of the operating portion 62 flicks the oscillating portion 72.

Time t27 indicates a time at which the transmission state of the transmitter 66 is changed from the second transmission state to the first transmission state. The transmitter 66 starts transmitting the second predetermined signal at time t27.

Time t28 indicates a time at which the transmitter 66 stops transmitting the second predetermined signal as the second transmission period T2 elapses from time t27. At time t28, the transmission state of the transmitter 66 is changed from the first transmission state to the second transmission state. At time t28 or later, the controller 46 of the further component 42 stops operation of the actuator 44 in response to receipt of the second predetermined signal. In a case where the further component 42 includes the transmission device 42A, the shifting of the transmission ratio is ended at time t28. In FIG. 10, at a time point at which the receiver 50 of the further component 42 receives the second predetermined signal, the sixth shifting to the adjacent stage is being performed. Therefore, the controller 46 of the further component 42 stops the actuator 44 upon completion of the sixth shifting to the adjacent stage.

### Second Embodiment

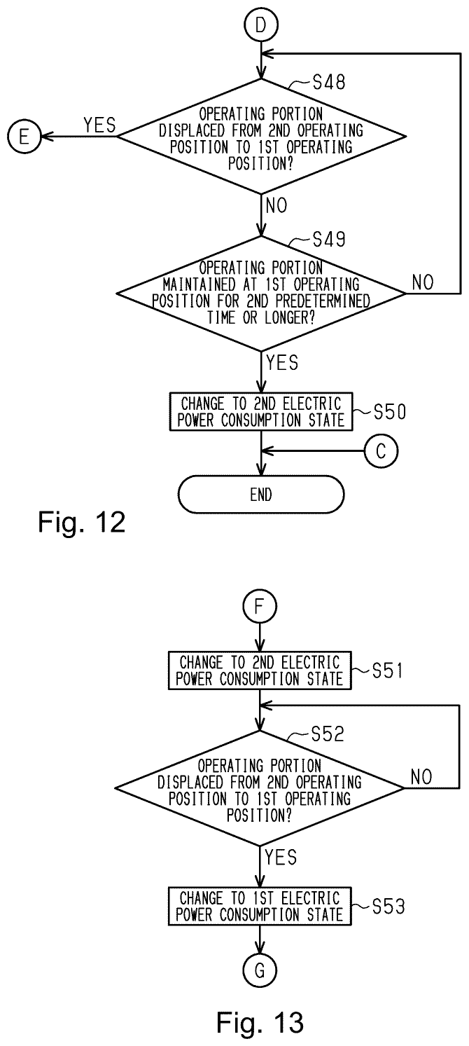

The human-powered vehicle component 60 will now be described with reference to FIGS. 5 and 11 to 13 in accordance with a second embodiment. Also, the human-powered vehicle component 60 of the second embodiment can be provided to the human-powered vehicle 10 of FIG. 1 in the same manner as in the first embodiment. Same reference numerals are given to those components of the human-powered vehicle component 60 in the second embodiment that are the same as the corresponding components in the first embodiment. Such components will not be described in detail.

The controller 68 of the present embodiment is, for example, configured to switch an electric power consumption state of the controller 68 in accordance with the operating state of the operating portion 62 between a first electric power consumption state and a second electric power consumption state in which less electric power is consumed than in the first electric power consumption state.

In the second electric power consumption state, for example, fewer functionalities are active than in the first electric power consumption state. For example, a boot program can be executed in the first electric power consumption state, and a boot program is not executed in the second electric power consumption state. The second electric power consumption state corresponds to, for example, a deep sleep state.

In a case where the operating portion 62 is displaced from the first operating position P1 to the second operating position P2 in the second electric power consumption state, for example, the controller 68 is configured to change the electric power consumption state from the second electric power consumption state to the first electric power consumption state and then from the first electric power consumption state to the second electric power consumption state. Further, in a case where the operating portion 62 is displaced from the second operating position P2 to the first operating position P1 in the second electric power consumption, for example, the controller 68 is configured to change the electric power consumption state from the second electric power consumption state to the first electric power consumption state.

In a case where the controller 68 changes the electric power consumption state from the second electric power consumption state to the first electric power consumption state and then the operating portion 62 is maintained at the second operating position P2 for a first predetermined time TX or longer, for example, the controller 68 is configured to change the electric power consumption state from the first electric power consumption state to the second electric power consumption state.

In a case where the operating portion 62 is displaced from the second operating position P2 to the first operating position P1 and then the operating portion 62 is maintained at the first operating position P1 for a second predetermined time TY or longer after the electric power consumption state is changed from the second electric power consumption state to the first electric power consumption state, for example, the controller 68 is configured to change the electric power consumption state from the first electric power consumption state to the second electric power consumption state.

In a case where the operating portion 62 is displaced from the second operating position P2 to the first operating position P1, for example, the controller 68 is configured to change the electric power consumption state from the first electric power consumption state to the second electric power consumption state and then maintain the second electric power consumption state until the operating portion 62 is displaced from the first operating position P1 to the second operating position P2.

The controller 68 is, for example, configured to control the transmitter 66 so that the predetermined signal is transmitted in a case where the electric power consumption state is changed from the second electric power consumption state to the first electric power consumption state. In a case where the electric power consumption state is changed from the second electric power consumption state to the first electric power consumption state, for example, the controller 68 controls the transmitter 66 to transmit the predetermined signal and then changes the electric power consumption state from the first electric power consumption state to the second electric power consumption state. As the operating portion 62 is displaced from the first operating position P1 to the second operating position P2, for example, the controller 68 controls the transmitter 66 to transmit the predetermined signal and then changes the electric power consumption state from the first electric power consumption state to the second electric power consumption state. As the operating portion 62 is displaced from the second operating position P2 to the first operating position P1, for example, the controller 68 controls the transmitter 66 to transmit the predetermined signal and then changes the electric power consumption state from the first electric power consumption state to the second electric power consumption state.

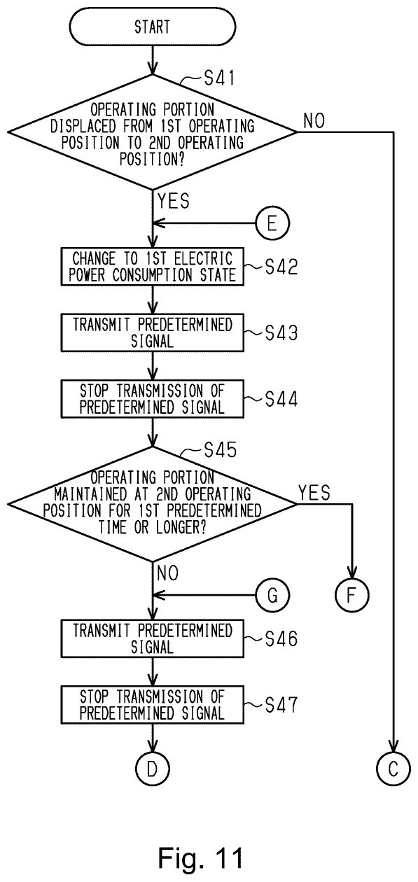

A process executed by the controller 68 to transmit the predetermined signal will now be described with reference to FIGS. 11 to 13. In a case where electric power is supplied to the controller 68, for example, the controller 68 starts the process of the flowchart shown in FIG. 11 from step S41. In a case where the process of the flowcharts shown in FIGS. 11 to 13 ends, for example, the controller 68 repeats the process from step S41 in predetermined cycles until the supply of electric power is stopped.

In step S41, the controller 68 determines whether the operating portion 62 is displaced from the first operating position P1 to the second operating position P2. For example, the controller 68 determines that the operating portion 62 is displaced from the first operating position P1 to the second operating position P2 based on the output of the operation detector 94. For example, the controller 68 determines that the operating portion 62 is displaced from the first operating position P1 to the second operating position P2 in a case where the controller 68 receives a detection signal from the operation detector 94. In a case where the operating portion 62 is not displaced from the first operating position P1 to the second operating position P2, the controller 68 ends the process shown in FIGS. 11 to 13. For example, a case where the operating portion 62 is not displaced from the first operating position P1 to the second operating position P2 is a case where the operating portion 62 is maintained at the first operating position P1. In a case where the operating portion 62 is displaced from the first operating position P1 to the second operating position P2, the controller 68 proceeds to step S42.

In step S42, the controller 68 sets the electric power consumption state to the first electric power consumption state, and then proceeds to step S43. The controller 68 changes the electric power consumption state from the second electric power consumption state to the first electric power consumption state in step S42. In step S43, the controller 68 controls the transmitter 66 to transmit the predetermined signal, and then proceeds to step S44. For example, the controller 68 causes the transmitter 66 to transmit the first predetermined signal in step S43. In step S44, the controller 68 controls the transmitter 66 to stop the transmission of the predetermined signal, and then proceeds to step S45. The period from the initiation of the transmission of the predetermined signal in step S43 until the termination of the transmission of the predetermined signal in step S44 corresponds to the first transmission period T1.

In step S45, the controller 68 determines whether the operating portion 62 is maintained at the second operating position P2 for the first predetermined time TX or longer. For example, the controller 68 determines that the operating portion 62 is maintained at the second operating position P2 for the first predetermined time TX or longer in a case where the detection signal is continuously output from the operation detector 94 for the first predetermined time TX or longer. In a case where the operating portion 62 is displaced from the first operating position P1 to the second operating position P2 and then displaced to the first operating position P1 before the first predetermined time TX elapses, the controller 68 determines that the operating portion 62 is not maintained at the second operating position P2 for the first predetermined time TX or longer. In a case where the operating portion 62 is displaced from the second operating position P2 to the first operating position P1, the controller 68 proceeds to step S46.

In step S46, the controller 68 controls the transmitter 66 to transmit the predetermined signal, and then proceeds to step S47. For example, the controller 68 causes the transmitter 66 to transmit the second predetermined signal in step S46. In step S47, the controller 68 controls the transmitter 66 to stop the transmission of the predetermined signal, and then proceeds to step S48. The period from the initiation of the transmission of the predetermined signal in step S46 until the termination of the transmission of the predetermined signal in step S47 corresponds to the second transmission period T2.

In step S48, the controller 68 determines whether the operating portion 62 is displaced from the second operating position P2 to the first operating position P1. In a case where the operating portion 62 is displaced from the second operating position P2 to the first operating position P1, the controller 68 proceeds to step S42. In a case where the operating portion 62 is not displaced from the second operating position P2 to the first operating position P1, the controller 68 proceeds to step S49.

In step S49, the controller 68 determines whether the operating portion 62 is maintained at the first operating position P1 for the second predetermined time TY or longer. In a case where the operating portion 62 is not maintained at the first operating position P1 for the second predetermined time TY or longer, the controller 68 proceeds to step S48. In a case where the operating portion 62 is maintained at the first operating position P1 for the second predetermined time TY or longer, the controller 68 proceeds to step S50. In step S50, the controller 68 changes the electric power consumption state from the first electric power consumption state to the second electric power consumption state, and then ends the process shown in FIGS. 11 to 13.

In a case where the operating portion 62 is maintained at the second operating position P2 for the first predetermined time or longer in step S45, the controller 68 proceeds to step S51. In step S51, the controller 68 changes the electric power consumption state from the first electric power consumption state to the second electric power consumption state, and then proceeds to step S52. In step S52, the controller 68 determines whether the operating portion 62 is displaced from the second operating position P2 to the first operating position P1. The controller 68 repeats step S52 until the operating portion 62 is displaced from the second operating position P2 to the first operating position P1. In a case where the operating portion 62 is displaced from the second operating position P2 to the first operating position P1, the controller 68 proceeds to step S53. In step S53, the controller 68 sets the electric power consumption state to the first electric power consumption state, and then proceeds to step S46.

### Third Embodiment

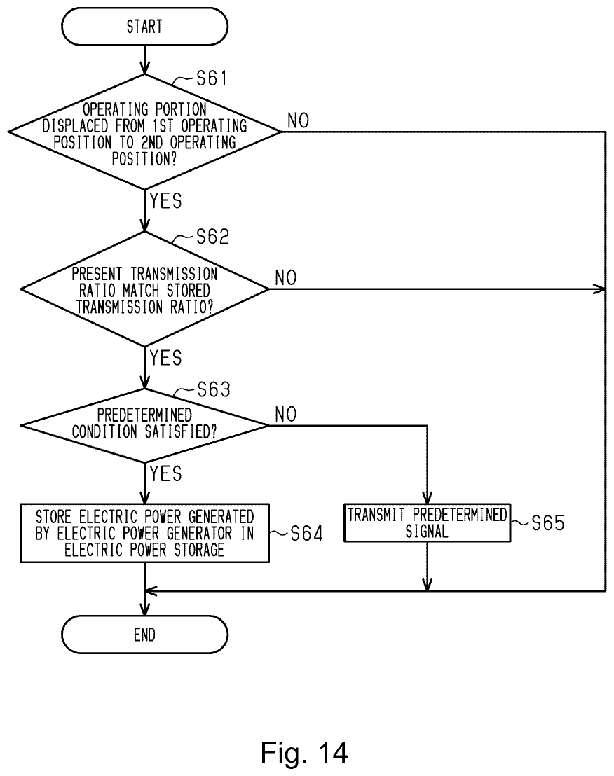

The human-powered vehicle component 60 will now be described with reference to FIG. 14 in accordance with a third embodiment. Also, the human-powered vehicle component 60 of the third embodiment can be provided to the human-powered vehicle 10 of FIG. 1 in the same manner as in the first embodiment. Same reference numerals are given to those components of the human-powered vehicle component 60 in the third embodiment that are the same as the corresponding components in the first and second embodiments. Such components will not be described in detail.

The controller 68 of the present embodiment is, for example, configured to control the transmitter 66 so that the predetermined signal is not transmitted in a case where the operating portion 62 is operated and a predetermined condition related to the further component 42 is satisfied. The controller 68 of the present embodiment is, for example, configured to control the transmitter 66 so that the predetermined signal is transmitted in a case where the operating portion 62 is operated and the predetermined condition is not satisfied.

The predetermined condition is satisfied, for example, in a case where the transmission ratio is less than or equal to a first transmission ratio or greater than or equal to a second transmission ratio that is greater than the first transmission ratio. The predetermined condition in a case where the shifting instruction is the first shifting instruction differs from the predetermined condition in a case where the shifting instruction is the second shifting instruction. In a case where the shifting instruction includes the second shifting instruction, for example, the predetermined condition is satisfied if the transmission ratio is less than or equal to the first transmission ratio. In a case where the shifting instruction includes the first shifting instruction, for example, the predetermined condition is satisfied if the transmission ratio is greater than or equal to the second transmission ratio. The first transmission ratio is, for example, the minimum transmission ratio obtainable by the transmission device 42A. The first transmission ratio can be greater than the minimum transmission ratio obtainable by the transmission device 42A. The second transmission ratio is, for example, the maximum transmission ratio obtainable by the transmission device 42A. The second transmission ratio can be less than the maximum transmission ratio obtainable by the transmission device 42A. At least one of the first transmission ratio and the second transmission ratio can be changed.

A process executed by the controller 68 to transmit the predetermined signal will now be described with reference to FIG. 14. In a case where electric power is supplied to the controller 68, for example, the controller 68 starts the process of the flowchart shown in FIG. 14 from step S61. In a case where the process of the flowchart shown in FIG. 14 ends, for example, the controller 68 repeats the process from step S61 in predetermined cycles until the supply of electric power is stopped.

In step S61, the controller 68 determines whether the operating portion 62 is displaced from the first operating position P1 to the second operating position P2. In a case where the operating portion 62 is not displaced from the first operating position P1 to the second operating position P2, the controller 68 ends the process shown in FIG. 14. In a case where the operating portion 62 is displaced from the first operating position P1 to the second operating position P2, the controller 68 proceeds to step S62.

In step S62, the controller 68 determines whether the present transmission ratio matches the transmission ratio that is stored. For example, the controller 68 obtains the present transmission ratio from the controller 46 of the further component 42 through communication with the further component 42. The controller 68 determines, for example, whether the obtained present transmission ratio matches the transmission ratio stored in the storage 92 of the component 60. The controller 46 of the further component 42 can obtain the present transmission ratio from a sensor that detects position information of the transmission device 42A. Alternatively, the controller 46 of the further component 42 can obtain the transmission ratio stored in the storage 48 of the further component 42 as the present transmission ratio. For example, the controller 68 can be configured to control the storage 92 to store the transmission history of the predetermined signal. For example, the controller 68 obtains the stored transmission ratio from the transmission history of the predetermined signal that is stored in the storage 92. In a case where the present transmission ratio does not match the stored transmission ratio, the controller 68 ends the process shown in FIG. 14. In a case where the present transmission ratio matches the stored transmission ratio, the controller 68 proceeds to step S63.

In step S63, the controller 68 determines whether the predetermined condition is satisfied. In a case where the predetermined condition is satisfied, the controller 68 proceeds to step S64. In step S64, the controller 68 stores the electric power generated by the electric power generator 64 in the electric power storage 88, and then ends the process shown in FIG. 14.

In a case where the predetermined condition is not satisfied in step S63, the controller 68 proceeds to step S65. In step S65, the controller 68 transmits the predetermined signal, and then ends the process shown in FIG. 14.

Step S62 can be omitted. In a case where step S62 is omitted and an affirmative determination is given in step S61, the controller 68 proceeds to step S63. In step S65, the controller 68 can transmit the predetermined signal and then store the electric power generated by the electric power generator 64 in the electric power storage 88.

### Fourth Embodiment

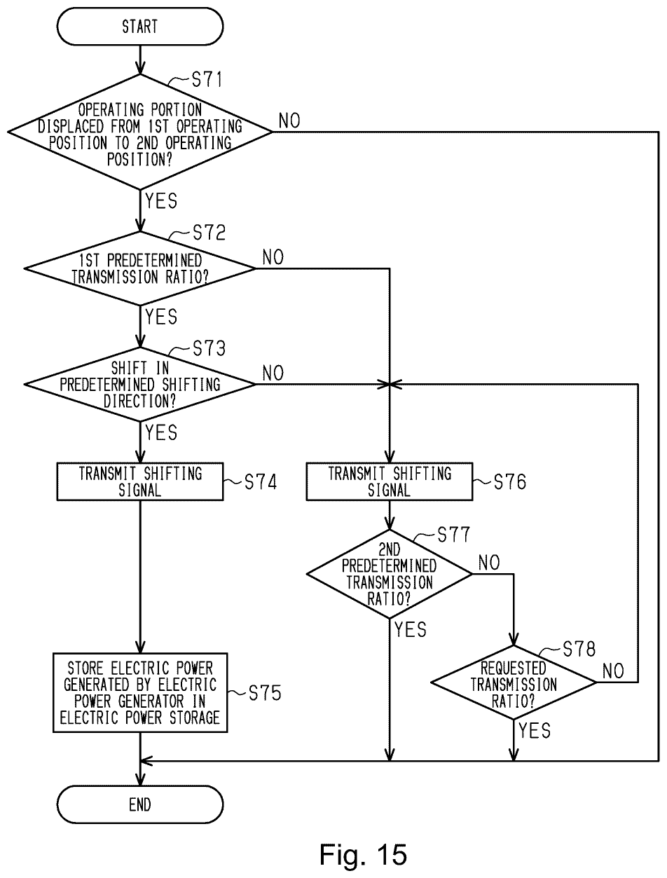

The human-powered vehicle component 60 will now be described with reference to FIGS. 5 and 15 in accordance with a fourth embodiment. Also, the human-powered vehicle component 60 of the fourth embodiment can be provided to the human-powered vehicle 10 of FIG. 1 in the same manner as in the first embodiment. Same reference numerals are given to those components of the human-powered vehicle component 60 in the fourth embodiment that are the same as the corresponding components in the first to third embodiments. Such components will not be described in detail.

The controller 68 of the present embodiment is, for example, configured to control the transmitter 66 so that the predetermined signal is not transmitted in a case where the operating portion 62 is operated and a predetermined condition related to the further component 42 is satisfied. The controller 68 of the present embodiment is, for example, configured to control the transmitter 66 so that the predetermined signal is transmitted in a case where the operating portion 62 is operated and the predetermined condition is not satisfied. The predetermined signal of the present embodiment includes, for example, a shifting instruction that actuates the transmission device 42A to shift the transmission ratio in accordance with a shifting request. For example, the controller 68 generates a shifting request for shifting by one or more stages in accordance with the duration in which the operating portion 62 is operated. For example, the controller 68 generates a shifting request for shifting by a greater number of shift stages as the duration in the operating portion 62 is maintained at the second operating position P2 increases.

The predetermined condition of the present embodiment is satisfied, for example, in a case where the shifting request is for shifting the transmission ratio by two or more stages and the transmission ratio shifted by two or more stages in response to the shifting request becomes greater than the maximum transmission ratio or less than the minimum transmission ratio. The predetermined condition is satisfied, for example, in a case where the transmission ratio is a first predetermined transmission ratio and the shifting request is for shifting in a predetermined shifting direction. The first predetermined transmission ratio includes, for example, a transmission ratio that is one stage smaller than the maximum transmission ratio and a transmission ratio that is one stage larger than the minimum transmission ratio. In a case where the first predetermined transmission ratio is a transmission ratio that is one stage smaller than the maximum transmission ratio, the predetermined shifting direction corresponds to a direction in which the transmission ratio increases. In a case where the first predetermined transmission ratio is a transmission ratio that is one stage larger than the maximum transmission ratio, the predetermined shifting direction corresponds to a direction in which the transmission ratio decreases.

In a case where the transmission ratio is the first predetermined transmission ratio and the shifting request is for shifting in the predetermined shifting direction, for example, the controller 68 is configured to control the transmitter 66 to transmit a shifting signal. The shifting signal includes, for example, a shifting instruction that shifts the transmission ratio by only one stage. In a case where the shifting request is for shifting the transmission ratio by two or more stages and the transmission ratio shifted by two or more stages in response to the shifting request is less than or equal to the maximum transmission ratio or greater than or equal to the minimum transmission ratio, for example, the controller 68 transmits a plurality of shifting signals in accordance with the shifting request. In a case where the shifting request is for shifting the transmission ratio by two or more stages and the transmission ratio shifted by two or more stages in response to the shifting request becomes greater than the maximum transmission ratio or less than the minimum transmission ratio, for example, the controller 68 transmits a smaller number of shifting signals than the number of shifting signals that is in accordance with the shifting request.

In a case where the shifting request is for shifting the transmission ratio by two or more stages, for example, the predetermined signal of the present embodiment corresponds to a plurality of predetermined signals transmitted until the transmission ratio satisfies the shifting request. For example, the predetermined signal of the present embodiment does not correspond to the shifting signal transmitted in a case where the shifting request is for shifting the transmission ratio by one stage. For example, the predetermined signal of the present embodiment does not correspond to the shifting signals transmitted in a case where the shifting request is for shifting the transmission ratio by two or more stages and the transmission ratio shifted by two or more stages in response to the shifting request becomes greater than the maximum transmission ratio or becomes less than the minimum transmission ratio. The number of such shifting signals is less than the number of shifting signals that is in accordance with the shifting request.

A process executed by the controller 68 to transmit the predetermined signal will now be described with reference to FIG. 15. In a case where electric power is supplied to the controller 68, for example, the controller 68 starts the process of the flowchart shown in FIG. 15 from step S71. In a case where the process of the flowchart shown in FIG. 15 ends, for example, the controller 68 repeats the process from step S71 in predetermined cycles until the supply of electric power is stopped.

In step S71, the controller 68 determines whether the operating portion 62 is displaced from the first operating position P1 to the second operating position P2. In a case where the operating portion 62 is not displaced from the first operating position P1 to the second operating position P2, the controller 68 ends the process. In a case where the operating portion 62 is displaced from the first operating position P1 to the second operating position P2, the controller 68 proceeds to step S72.

In step S72, the controller 68 determines whether the transmission ratio is the first predetermined transmission ratio. In a case where the transmission ratio is the first predetermined transmission ratio, the controller 68 proceeds to step S73. In step S73, the controller 68 determines whether shifting is to be performed in the predetermined shifting direction. For example, the controller 68 determines that shifting is to be performed in the predetermined shifting direction in a case where the operating portion 62 operated in step S71 is for performing shifting in the predetermined shifting direction. In a case where shifting is to be performed in the predetermined shifting direction, the controller 68 proceeds to step S74.

In step S74, the controller 68 transmits the shifting signal, and then proceeds to step S75. In step S75, the controller 68 stores the electric power generated by the electric power generator 64 in the electric power storage 88, and then ends the process shown in FIG. 15. In a case where an affirmative determination is given in step S72 and an affirmative determination is given in step S73, the transmission device 42A performs shifting by only one stage. In a case where an affirmative determination is given in step S72 and an affirmative determination is given in step S73, for example, the controller 68 uses the electric power generated by the electric power generator 64 in accordance with the displacement of the operating portion 62 from the first operating position P1 to the second operating position P2 for the transmission of the shifting signal, and then stores the electric power generated by the electric power generator 64 in accordance with the displacement of the operating portion 62 from the second operating position P2 to the first operating position P1 in the electric power storage 88.

In a case where the transmission ratio is not the first predetermined transmission ratio in step S72, the controller 68 proceeds to step S76. In a case where shifting is not to be performed in the predetermined shifting direction in step S73, the controller 68 proceeds to step S76.

In step S76, the controller 68 transmits the shifting signal, and then proceeds to step S77. In step S77, the controller 68 determines whether the transmission ratio is a second predetermined transmission ratio. The second predetermined transmission ratio is, for example, the maximum transmission ratio or the minimum transmission ratio. In a case where the transmission ratio is the second predetermined transmission ratio, the controller 68 ends the process shown in FIG. 15.

In a case where the controller 68 is not the second predetermined transmission ratio in step S77, the controller 68 proceeds to step S78. In step S78, the controller 68 determines whether the transmission ratio corresponds to a requested transmission ratio. For example, the requested transmission ratio is determined in accordance with a shifting request that is set based on the time length from displacement of the operating portion 62 from the first operating position P1 to the second operating position P2 to displacement of the operating portion 62 from the second operating position P2 to the first operating position P1. In a case where the transmission ratio is the required transmission ratio, the controller 68 ends the process shown in FIG. 15. In a case where the transmission ratio is not the required transmission ratio, the controller 68 proceeds to step S76.

In a case where a negative determination is given in step S72 or a case where a negative determination is given in S73, the transmission device 42A shifts the transmission ratio in the predetermined shifting direction over two or more stages. The controller 68 repeats the transmission of the shifting signal until the transmission ratio reaches the second predetermined transmission ratio or the requested transmission ratio through steps S76, S77, and S78.

Step S74 can be omitted from FIG. 15. In a case where step S74 is omitted from FIG. 15, if an affirmative determination is given in step S73, the controller 68 proceeds to step S75.

### Fifth Embodiment

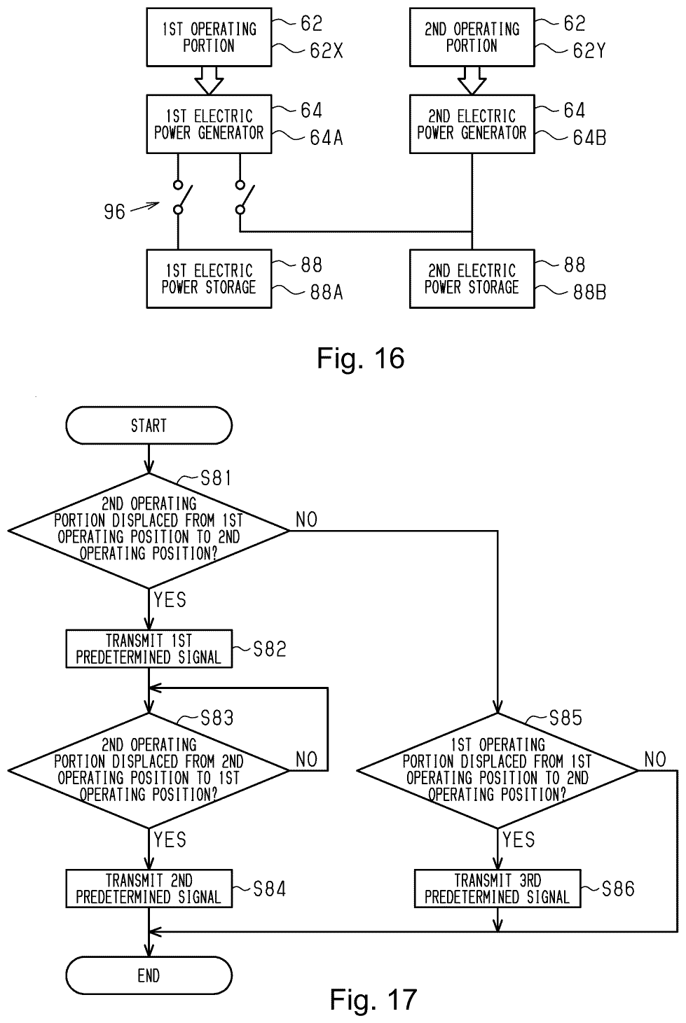

The human-powered vehicle component 60 will now be described with reference to FIGS. 5, 16, and 17 in accordance with a fifth embodiment. Also, the human-powered vehicle component 60 of the fifth embodiment can be provided to the human-powered vehicle 10 of FIG. 1 in the same manner as in the first embodiment. Same reference numerals are given to those components of the human-powered vehicle component 60 in the fifth embodiment that are the same as the corresponding components in the first to fourth embodiments. Such components will not be described in detail.

The further component 42 of the present embodiment includes a first further component and a second further component differing from the first further component. The controller 68 is configured to transmit the predetermined signal differently in a case where the operating portion 62 is operated to actuate the first further component and a case where the operating portion 62 is operated to actuate the second further component. The first further component is one of the front transmission device and the rear transmission device 42R, and the second further component is the other one of the front transmission device and the rear transmission device 42R. The rear transmission device 42R has, for example, three or more shift stages. The front transmission device has, for example, a smaller number of shift stages than the rear transmission device 42R. The front transmission has, for example, two shift stages. In the present embodiment, the first further component is the front transmission device, and the second further component is the rear transmission device 42R.

The operating portion 62 includes, for example, a first operating portion 62X for the first further component and a second operating portion 62Y for the second further component. The controller 68 transmits a third predetermined signal in accordance with an operating state of the first operating portion 62X. For example, the controller 68 transmits the first predetermined signal and the second predetermined signal in accordance with an operating state of the second operating portion 62Y. The third predetermined signal includes, for example, a shifting instruction for shifting the transmission ratio by one stage. The third predetermined signal can be the same as the first predetermined signal. In a case where the front transmission receives the third predetermined signal, for example, the front transmission device operates the actuator 44 to shift the transmission ratio by only one stage.

The predetermined signal of the present embodiment includes the first predetermined signal, the second predetermined signal, and the third predetermined signal. In a case where the first operating portion 62X is operated, the third predetermined signal is transmitted. Further, in a case where the second operating portion 62Y is operated, the first predetermined signal and the second predetermined signal are transmitted. In this manner, the predetermined signal is transmitted differently in a case where the first operating portion 62X is operated and a case where the second operating portion 62Y is operated.

The electric power generator 64 includes, for example, a first electric power generator 64A that generates electric power in accordance with operation of the first operating portion 62X, and a second electric power generator 64B that generates electric power in accordance with operation of the second operating portion 62Y. The electric power storage 88 includes, for example, first electric power storage 88A that stores the electric power generated by the first electric power generator 64A, and second electric power storage 88B that stores the electric power generated by the second electric power generator 64B.

The electric power generated by the first electric power generator 64A can be stored, for example, in the first electric power storage 88A and the second electric power storage 88B. The electric power generated by the second electric power generator 64B can be stored, for example, only in the second electric power storage 88B. The component 60 includes, for example, a switching unit 96 for storing the electric power generated by the first electric power generator 64A to one of the first electric power storage 88A and the second electric power storage 88B. The controller 68 controls the switching unit 96 to select a state in which the electric power generated by the first electric power generator 64A is stored in the first electric power storage 88A and a state in which the electric power generated by the first electric power generator 64A is stored in the second electric power storage 88B. The controller 68 can be configured to control the switching unit 96 so that the electric power generated by the first electric power generator 64A is stored in both the first electric power storage 88A and the second electric power storage 88B.

A process executed by the controller 68 to transmit the predetermined signal will now be described with reference to FIG. 17. In a case where electric power is supplied to the controller 68, for example, the controller 68 starts the process of the flowchart shown in FIG. 17 from step S81. In a case where the process of the flowchart shown in FIG. 17 ends, for example, the controller 68 repeats the process from step S81 in predetermined cycles until the supply of electric power is stopped.

In step S81, the controller 68 determines whether the second operating portion 62Y is displaced from the first operating position P1 to the second operating position P2. In a case where the second operating portion 62Y is displaced from the first operating position P1 to the second operating position P2, the controller 68 proceeds to step S82. In step S82, the controller 68 transmits the first predetermined signal, and then proceeds to step S83.

In step S83, the controller 68 determines whether the second operating portion 62Y is displaced from the second operating position P2 to the first operating position P1. In a case where the second operating portion 62Y is not displaced from the second operating position P2 to the first operating position P1, the controller 68 repeats step S83. In a case where the second operating portion 62Y is displaced from the second operating position P2 to the first operating position P1, the controller 68 proceeds to step S84. In step S84, the controller 68 transmits the second predetermined signal, and then ends the process shown in FIG. 17.

In a case where the second operating portion 62Y is not displaced from the first operating position P1 to the second operating position P2 in step S81, the controller 68 proceeds to step S85. In step S85, the controller 68 determines whether the first operating portion 62X is displaced from the first operating position P1 to the second operating position P2. In a case where the second operating portion 62Y is not displaced from the first operating position P1 to the second operating position P2, the controller 68 ends the process shown in FIG. 17. In a case where the second operating portion 62Y is displaced from the first operating position P1 to the second operating position P2, the controller 68 proceeds to step S86. In step S86, the controller 68 transmits the third predetermined signal, and then ends the process shown in FIG. 17.

The electric power generated by the first electric power generator 64A in a case where the first operating portion 62X is displaced from the second operating position P2 to the first operating position P1 is stored, for example, in the second electric power storage 88B. The controller 68 is, for example, configured to control the switching unit 96 after the first operating portion 62X is displaced from the first operating position P1 to the second operating position P2 so that the electric power generated by the first electric power generator 64A is stored in the second electric power storage 88B.

### Modifications

The description related with the above embodiments exemplifies, without any intention to limit, applicable forms of a component for a human-powered vehicle. The human-powered vehicle component according to the present disclosure can be applied to, for example, modifications of the embodiments that are described below and combinations of at least two of the modifications that do not contradict each other. In the modifications described hereafter, same reference numerals are given to those components that are the same as the corresponding components of the above embodiments. Such components will not be described in detail.

The transmission device 42A can be configured to shift the transmission ratio in stages, and the controller 68 can be configured to control the transmission device 42A so that a moving speed of the transmission device 42A differs between a case where the transmission ratio is shifted by one stage and a case where the transmission ratio is shifted by two or more stages. For example, the controller 68 transmits to the transmission device 42A an actuation instruction for increasing the moving speed of the transmission device 42A to be higher in a case where the transmission ratio is shifted by two or more stages than in a case where the transmission ratio is shifted by one stage. In a case where the actuator 44 includes a motor, for example, the transmission device 42A changes the rotational speed of the motor so that the time required for completing shifting of the transmission ratio by one stage is shortened.

The controller 68 can be configured to control the transmitter 66 so that the transmission state becomes the first transmission state in only one of a case where the operating portion 62 is displaced from the first operating position P1 to the second operating position P2 and a case where the operating portion 62 is displaced from the second operating position P2 to the first operating position P1. In the first embodiment, the controller 68 can be configured to control the transmitter 66 so that the predetermined signal is transmitted in only one of a case where the operating portion 62 is displaced from the first operating position P1 to the second operating position P2 and a case where the operating portion 62 is displaced from the second operating position P2 to the first operating position P1. The controller 68 is, for example, configured to control the transmitter 66 so that the transmission state becomes the second transmission state in a case where the operating portion 62 is displaced from the second operating position P2 to the first operating position P1. The controller 68 is, for example, configured to control the transmitter 66 so that the predetermined signal is not transmitted in a case where the operating portion 62 is displaced from the second operating position P2 to the first operating position P1. The controller 68 is, for example, configured to control the transmitter 66 so that the predetermined signal is transmitted in a case where the operating portion 62 is displaced from the first operating position P1 to the second operating position P2 and the predetermined signal is not transmitted in a case where the operating portion 62 is displaced from the second operating position P2 to the first operating position P1. In the present modification, for example, the predetermined signal includes a shifting instruction for shifting by only one stage. In the present modification, for example, the controller 68 causes the transmission device 42A to change the shift stage by only one stage in response to operation of the operating portion 62, regardless of the duration in which the operating portion 62 is maintained at the second operating position P2.

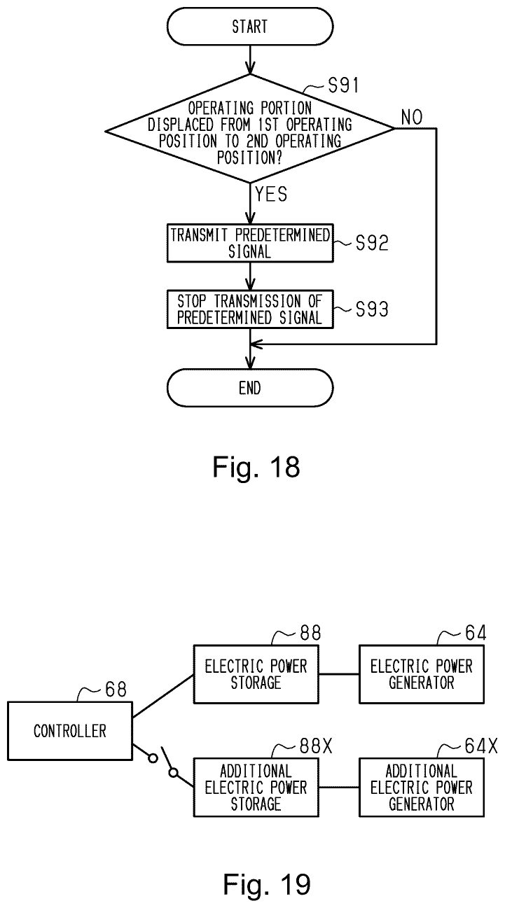

A process executed by the controller 68 of the present modification to transmit the predetermined signal will now be described with reference to FIG. 18. In a case where electric power is supplied to the controller 68, for example, the controller 68 starts the process of the flowchart shown in FIG. 18 from step S91. In a case where the process of the flowchart shown in FIG. 18 ends, for example, the controller 68 repeats the process from step S91 in predetermined cycles until the supply of electric power is stopped.

In step S91, the controller 68 determines whether the operating portion 62 is displaced from the first operating position P1 to the second operating position P2. In a case where the operating portion 62 is not displaced from the first operating position P1 to the second operating position P2, the controller 68 ends the process. In a case where the operating portion 62 is displaced from the first operating position P1 to the second operating position P2, the controller 68 proceeds to step S92 and transmits the predetermined signal. Then, the controller 68 proceeds to step S93. In step S93, the controller 68 stops the transmission of the predetermined signal, and then ends the process shown in FIG. 18.

In a case where the transmitter 66 is connected to the receiver 50 by an electric wire, the first transmission state can be an energized state, and the second transmission state can be a non-energized state.

The first transmission state can be a state that allows for transmission of a signal by the transmitter 66 using an amplification circuit, and the second transmission state can be a state that allows for transmission of a signal by the transmitter 66 without using an amplification circuit. The transmitter 66 is configured to consume less electric power in a case where the amplification circuit is not used. Therefore, even if the transmitter 66 cyclically transmits a signal in the second transmission state at the same frequency as the predetermined signal transmitted in the first transmission state, the transmitter 66 is configured to consume less electric power in the second transmission state than in the first transmission state.

The component 60 can include additional electric power storage 88X shown in FIG. 19. The electric power stored in the electric power storage 88 is supplied to the controller 68 in the first electric power consumption state. The electric power stored in the additional electric power storage 88X is supplied to the controller 68 in the second electric power consumption state. In the present modification, the component 60 can include an additional electric power generator 64X that supplies electric power to the additional electric power storage 88X. For example, the additional electric power generator 64X has the same configuration as the electric power generator 64. The additional electric power generator 64X can be configured to generate electric power with the vibration of the human-powered vehicle 10 in a case where the human-powered vehicle 10 is traveling. The component 60 does not have to include the additional electric power generator 64X, and the additional electric power storage 88X can receive excess electric power from the electric power storage 88.

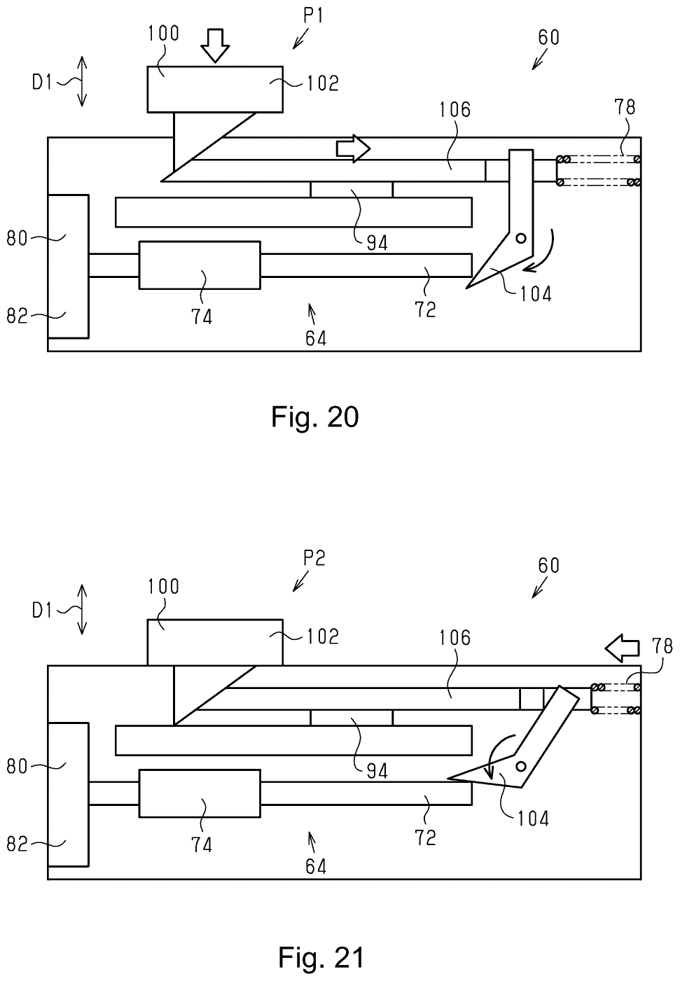

The configuration of the operating portion 62 can be changed as long as the electric power generator 64 performs electric power generation. The operating portion 62 can be, for example, an operating portion 100 shown in FIGS. 20 and 21. The operating portion 100 is configured so that the operating portion 100 partially extends in a direction differing from the oscillation direction of the oscillating portion 72. The operating portion 100 includes a first part 102, a second part 104, and a third part 106. The first part 102 includes, for example, a part located outside the housing 70. The second part 104 is, for example, configured to contact the electric power generator 64. The third part 106 transmits the movement of the first part 102 to the second part 104. The third part 106 is configured to be moved in a direction intersecting the first direction D1 in a case where the user pushes the first part 102 in the first direction D1. The second part 104 is configured to be rotated by the movement of the third part 106 in the direction intersecting the first direction D1. The rotated second part 104 comes into contact with the oscillating portion 72 such that the oscillating portion 72 is vibrated. In the present modification, for example, the operation detector 94 is configured to detect the movement of the third part 106 in a direction intersecting the first direction D1. The operation detector 94 can be configured to detect the position of the third part 106 in a direction intersecting the first direction D1.

The further component 42 can include at least one of an adjustable seatpost, a suspension, an assist unit, a brake device, and a lamp, instead of or in addition to the transmission device 42A. An adjustable seatpost is, for example, configured to change the height of the saddle 16A relative to the frame 16 in response to the predetermined signal. A suspension includes, for example, at least one of a front suspension and a rear suspension. The suspension is, for example, configured to change the maximum length of the suspension in response to the predetermined signal. An assist unit is, for example, configured to change a ratio of motor driving force to human driving force in response to the predetermined signal. A brake device includes, for example, at least one of a front brake device that brakes the front wheel 12F and a rear brake device that brakes the rear wheel 12R. The brake device is, for example, configured to change the braking force applied to the human-powered vehicle 10 in response to the predetermined signal. A lamp is, for example, configured to change the illumination state of the light source in response to the predetermined signal.

As long as the component 60 for a human-powered vehicle is configured as described below, any other configuration can be omitted. The component 60 includes the operating portion 62 operable by a user, the electric power generator 64, the transmitter 66, and the controller 68. The electric power generator 64 is configured to generate electric power in accordance with displacement of the operating portion 62 in a case where the user operates the operating portion 62. The transmitter 66 is configured to transmit a predetermined signal to the further component 42 with the electric power generated by the electric power generator 64. The controller 68 is configured to control the transmitter 66 so that the predetermined signal is transmitted in response to operation of the operating portion 62. The controller 68 is configured to control the transmitter 66 to change a transmission state of the predetermined signal in accordance with an operating state of the operating portion 62 in a case where the operating portion 62 is operated.

As long as the component 60 for a human-powered vehicle is configured as described below, any other configuration can be omitted. The component 60 includes the operating portion 62 operable by a user, the electric power generator 64, the transmitter 66, and the controller 68. The electric power generator 64 is configured to generate electric power in accordance with displacement of the operating portion 62 in a case where the user operates the operating portion 62. The transmitter 66 is configured to transmit a predetermined signal to the further component 42. The controller 68 is configured to be actuated by the electric power generated by the electric power generator 64. The controller 68 is configured to control the transmitter 66 so that the predetermined signal is transmitted in response to operation of the operating portion 62. The controller 68 is configured to switch an electric power consumption state of the controller 68 in accordance with an operating state of the operating portion 62 between a first electric power consumption state and a second electric power consumption state in which less electric power is consumed than in the first electric power consumption state.

The electric power generator 64 can be changed as long as the electric power generator 64 is configured to generate electric power in accordance with the displacement of the operating portion 62. The electric power generator 64 can include a magnet and a coil having relative positions that change in accordance with the displacement of the operating portion 62. The electric power generator 64 can include a piezoelectric element to which pressure is applied by the displacement of the operating portion 62.

As long as the component 60 for a human-powered vehicle is configured as described below, any other configuration can be omitted. The component 60 includes the operating portion 62 operable by a user, the electric power generator 64, the transmitter 66, and the controller 68. The electric power generator 64 is configured to generate electric power in accordance with displacement of the operating portion 62 in a case where the user operates the operating portion 62. The transmitter 66 is configured to transmit a predetermined signal to the further component 42. The controller 68 is configured to be actuated by the electric power generated by the electric power generator 64. The controller 68 is configured to control the transmitter 66 so that the predetermined signal is not transmitted in a case where the operating portion 62 is operated and a predetermined condition related to the further component 42 is satisfied. The controller 68 is configured to control the transmitter 66 so that the predetermined signal is transmitted in a case where the operating portion 62 is operated and the predetermined condition is not satisfied.

As long as the component 60 for a human-powered vehicle is configured as described below, any other configuration can be omitted. The component 60 includes the operating portion 62 operable by a user, the electric power generator 64, the transmitter 66, and the controller 68. The electric power generator 64 is configured to generate electric power in accordance with displacement of the operating portion 62 in a case where the user operates the operating portion 62. The transmitter 66 is configured to transmit a predetermined signal to the further component 42. The controller 68 is configured to be actuated by the electric power generated by the electric power generator 64. The further component 42 includes a first further component and a second further component differing from the first further component. The controller 68 is configured to transmit the predetermined signal differently in a case where the operating portion 62 is operated to actuate the first further component and a case where the operating portion 62 is operated to actuate the second further component.

In this specification, the phrase “at least one of” as used in this disclosure means “one or more” of a desired choice. As one example, the phrase “at least one of” as used in this disclosure means “only one single choice” or “both of two choices” if the number of its choices is two. As another example, the phrase “at least one of” as used in this disclosure means “only one single choice” or “any combination of two or more choices” if the number of its choices is three or more. Also, the term “and/or” as used in this disclosure means “either one of or both of.” For instance, the phrase “at least one of A and B” encompasses (1) A alone, (2) B alone, and (3) both A and B. The phrase “at least one of A, B, and C” encompasses (1) A alone, (2) B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Ordinal numerals such as “first”, “second”, and “third” are used in this disclosure only to distinguish members having the same name from one another and are not intended to have any special meaning.

What is claimed is:

1. A component for a human-powered vehicle, the component comprising:
an operating portion configured to be operable by a user;
an electric power generator configured to generate electric power in accordance with displacement of the operating portion in a case where the user operates the operating portion;
a transmitter configured to transmit a predetermined signal to a further component with the electric power generated by the electric power generator; and
a controller configured to control the transmitter so that the predetermined signal is transmitted in response to operation of the operating portion,
the controller being configured to control the transmitter to change a transmission state of the predetermined signal in accordance with an operating state of the operating portion in a case where the operating portion is operated.

2. The component according to claim 1, wherein
the operating portion is configured to be displaceable between a first operating position and a second operating position differing from the first operating position,
the controller is configured to control the transmitter so that the transmission state becomes a first transmission state in a case where the operating portion is displaced from the first operating position to the second operating position,
the controller is configured to control the transmitter so that the transmission state becomes a second transmission state in a case where the operating portion is displaced from the second operating position to the first operating position, and
the transmitter is configured to consume less electric power in the second transmission state than in the first transmission state.

3. The component according to claim 1, wherein
the operating portion is configured to be displaceable between a first operating position and a second operating position differing from the first operating position,
the controller is configured to control the transmitter so that the transmission state becomes a first transmission state in a case where the operating portion is displaced from the first operating position to the second operating position,
the controller is configured to control the transmitter so that the transmission state is maintained in a second transmission state while the operating portion is maintained at the second operating position after the operating portion is displaced from the first operating position to the second operating position, and
the transmitter is configured to consume less electric power in the second transmission state than in the first transmission state.

4. The component according to claim 1, wherein
the operating portion is configured to be displaceable between a first operating position and a second operating position differing from the first operating position,
the controller is configured to control the transmitter so that the predetermined signal is transmitted in a case where the operating portion is displaced from the first operating position to the second operating position, and
the controller is configured to control the transmitter so that the predetermined signal is not transmitted in a case where the operating portion is displaced from the second operating position to the first operating position.

5. The component according to claim 1, wherein
the operating portion is configured to be displaceable between a first operating position and a second operating position differing from the first operating position, and
the controller is configured to control the transmitter so that the predetermined signal is not transmitted while the operating portion is maintained at the second operating position after the operating portion is displaced from the first operating position to the second operating position.

6. A component for a human-powered vehicle, the component comprising:
an operating portion configured to be operable by a user;
an electric power generator configured to generate electric power in accordance with displacement of the operating portion in a case where the user operates the operating portion;
a transmitter configured to transmit a predetermined signal to a further component; and
a controller configured to be actuated by the electric power generated by the electric power generator,
the controller being configured to control the transmitter so that the predetermined signal being transmitted in response to operation of the operating portion, and
the controller being configured to switch an electric power consumption state of the controller in accordance with an operating state of the operating portion between a first electric power consumption state and a second electric power consumption state in which less electric power is consumed than in the first electric power consumption state.

7. The component according to claim 6, wherein
the operating portion is configured to be displaceable between a first operating position and a second operating position differing from the first operating position,
in a case where the operating portion is displaced from the first operating position to the second operating position in the second electric power consumption state, the controller is configured to change the electric power consumption state from the second electric power consumption state to the first electric power consumption state and then from the first electric power consumption state to the second electric power consumption state, and
in a case where the operating portion is displaced from the second operating position to the first operating position in the second electric power consumption state, the controller is configured to change the electric power consumption state from the second electric power consumption state to the first electric power consumption state.

8. The component according to claim 7, wherein
in a case where the controller changes the electric power consumption state from the second electric power consumption state to the first electric power consumption state and then the operating portion is maintained at the second operating portion for a first predetermined time or longer, the controller is configured to change the electric power consumption state from the first electric power consumption state to the second electric power consumption state.

9. The component according to claim 8, wherein
in a case where the operating portion is displaced from the second operating position to the first operating position and then the operating portion is maintained at the first operating position for a second predetermined time or longer after the electric power consumption state is changed from the second electric power consumption state to the first electric power consumption state, the controller is configured to change the electric power consumption state from the first electric power consumption state to the second electric power consumption state.

10. The component according to claim 6, wherein
the operating portion is configured to be displaceable between a first operating position and a second operating position differing from the first operating position, and
in a case where the operating portion is displaced from the second operating position to the first operating position, the controller is configured to change the electric power consumption state from the first electric power consumption state to the second electric power consumption state and maintain the second electric power consumption state until the operating portion is displaced from the first operating position to the second operating position.

11. The component according to claim 7, wherein
the controller is configured to control the transmitter so that the predetermined signal is transmitted in a case where the electric power consumption state is changed from the second electric power consumption state to the first electric power consumption state.

12. The component according to claim 8, wherein
the controller is configured to control the transmitter so that the predetermined signal is transmitted in at least one of a case where the operating portion is displaced from the first operating position to the second operating position and a case where the operating portion is displaced from the second operating position to the first operating position.

13. The component according to claim 1, wherein
the controller is configured to control the transmitter so that the predetermined signal is not transmitted in a case where the operating portion is operated and a predetermined condition related to the further component is satisfied, and
the controller is configured to control the transmitter so that the predetermined signal is transmitted in a case where the operating portion is operated and the predetermined condition is not satisfied.

14. A component for a human-powered vehicle, the component comprising:
an operating portion configured to be operable by a user;
an electric power generator configured to generate electric power in accordance with displacement of the operating portion in a case where the user operates the operating portion;
a transmitter configured to transmit a predetermined signal to a further component; and
a controller configured to be actuated by the electric power generated by the electric power generator,
the controller being configured to control the transmitter so that the predetermined signal is not transmitted in a case where the operating portion is operated and a predetermined condition related to the further component is satisfied, and
the controller being configured to control the transmitter so that the predetermined signal is transmitted in a case where the operating portion is operated and the predetermined condition is not satisfied.

15. The component according to claim 14, wherein
the further component includes a transmission device configured to shift a transmission ratio of the human-powered vehicle,
the predetermined signal includes a shifting instruction that actuates the transmission device to shift the transmission ratio, and
the predetermined condition is satisfied in a case where the transmission ratio is less than or equal to a first transmission ratio or greater than or equal to a second transmission ratio that is greater than the first transmission ratio.

16. The component according to claim 14, wherein
the further component includes a transmission device configured to shift a transmission ratio of the human-powered vehicle,
the transmission device is configured to shift the transmission ratio in stages,
the predetermined signal includes a shifting instruction that actuates the transmission device to shift the transmission ratio in accordance with a shifting request, and
the predetermined condition is satisfied in a case where the shifting request is for shifting the transmission ratio by two or more stages and the transmission ratio shifted by two or more stages in response to the shifting request becomes greater than a maximum transmission ratio or less than a minimum transmission ratio.

17. The component according to claim 16, wherein
the transmission device is configured to shift the transmission ratio in stages, and
the controller is configured to control the transmission device so that a moving speed of the transmission device differs between a case where the transmission ratio is shifted by one stage and a case where the transmission ratio is shifted by two or more stages.

18. The component according to claim 1, wherein
the further component includes a first further component and a second further component differing from the first further component, and
the controller is configured to transmit the predetermined signal differently in a case where the operating portion is operated to actuate the first further component and a case where the operating portion is operated to actuate the second further component.

19. A component for a human-powered vehicle, the component comprising:
an operating portion configured to be operable by a user;
an electric power generator configured to generate electric power in accordance with displacement of the operating portion in a case where the user operates the operating portion;
a transmitter configured to selectively transmit a predetermined signal to a first further component and a second further component differing from the first further component; and
a controller configured to be actuated by the electric power generated by the electric power generator, and
the controller being configured to transmit the predetermined signal differently in a case where the operating portion is operated to actuate the first further component and a case where the operating portion is operated to actuate the second further component.

20. The component according to claim 1, further comprising:
an operation detector that is separate from the electric power generator, and that is configured to detect the operating state of the operating portion.

21. The component according to claim 1, wherein
the electric power generator is configured to generate electric power through magnetostrictive electric power generation.

22. The component according to claim 21, wherein
the electric power generator includes
an oscillating portion oscillated by displacement of the operating portion and including a magnetostrictive member, and
a coil generating electric power through oscillation of the oscillating portion.
